(19) United States
(12) Patent Application Publication
(10) Pub. No.: US 2017/0038598 A1
(43) Pub. Date: Feb. 9, 2017

(54) ADJUSTABLE OPTICAL STEREOSCOPIC GLASSES

(71) Applicants: Jay Song, Aliso Viejo, CA (US); Lishang Zhou, Beijing (CN)

(72) Inventors: Jay Song, Aliso Viejo, CA (US); Lishang Zhou, Beijing (CN)

(21) Appl. No.: 14/637,439

(22) Filed: Mar. 4, 2015

(51) Int. Cl. G02B 27/22; G02B 7/18

(52) U.S. Cl. CPC G02B 27/2242; G02B 27/2235; G02B 7/1805

(57) ABSTRACT

The present invention provides an optical 3D stereoscopic glasses comprising a housing, a left lens assembly and a right lens assembly wherein the lens assemblies use refraction to create one of the following viewing modes: positive parallax hyperstereo viewing mode, positive parallax hypostereo viewing mode, negative parallax hyperstereo viewing mode, and negative parallax hypostereo viewing mode, which can causes a viewer to perceive 3D stereoscopic vision of a 2D image shown on a planar screen.

### CLAIM OF BENEFIT OF FILING DATE

This continuation-in-part patent application claims the benefit of U.S. patent application Ser. No. 14/478,945 titled “Adjustable Optical Stereoscopic Glasses” filed on Sep. 5, 2014, which claims the benefit of U.S. Provisional Patent Application Ser. No. 61/874,366 titled “Adjustable Optical Stereoscopic Glasses” filed on Sep. 6, 2013.

### FIELD OF INVENTION

The present invention relates to optical stereoscopic glasses. More particularly, the present invention relates to adjustable optical stereoscopic glasses that can perceive three-dimensional (“3D”) stereoscopic vision when viewing the two-dimensional (“2D”) content on a planar surface such as a screen.

### BACKGROUND OF INVENTION

Human eyes have 3D stereoscopic vision of objects in natural real space. This natural 3D stereoscopic vision of human is provided by his brain's combination of the offset image created by each eye. Referring to FIGS. 1(a), 1(d) and 1(e), human eyes (the left eye L and the right eye R) are located side-by-side separated by the interocular distance 1. The interocular distance 1 is generally about 60 mm˜65 mm in adults. The eyes' close side-by-side positioning allows each eye to take a view of the same area from a slightly different angle and thereby creating two offset images in a process known as binocular disparity. These offset images have plenty in common but are not exactly the same as each eye picks up visual information the other eye does not. The two offset images are processed and combined by the viewer's brain into a single final 3D stereoscopic image. The brain combines the two offset images by matching up their similarities and adding in the small differences. The small differences between the two offset images allow the brain to experience the 3D stereoscopic vision of the viewed content. Basically, when a viewer views an object in real space, his eyes focus and converge onto the object and the binocular disparity informs his brain to perceive depth and the location of the object is in real 3D space.

Currently, there are various techniques to create and view 3D stereoscopic content from a planar screen generally using the concept of horizontal parallax. Since human's two eyes must be positioned at the same elevation, horizontal (x-axis) parallax exists but the perpendicular (y-axis) parallax shall not exist. When viewing a conventional 3D content on a 2D planar screen (e.g., a movie screen), the viewer's eyes behave differently than they do in nature in that they focus on the planar screen but converge onto the object appearing in 3D space forming parallax. Basically, parallax is a displacement of difference in the apparent position of an object viewed along two different lines of sight. The parallax informs the viewer's brain that the objects viewed on the planar screen is stereoscopic in the viewing space.

When an object appearing in a conventional 3D stereoscopic content appears to exist between the viewer and the planar screen, this effect is known as negative parallax. It makes the object appear to “pop out” of the planar screen. When an object in a conventional 3D stereoscopic content appears to exist behind the planar screen, this effect is known as positive parallax. In order to provide 3D stereoscopic vision of conventional 3D stereoscopic content, such content must first be processed and viewed with (i) specific conventional 3D glasses (e.g., anaglyph glasses, polarized glasses, LED glasses, shuttered glasses, split image (adjacent side by side image) glasses or the like) and/or (ii) lenticular screen, interleaved screen, process separation screen, adaptive stereoscopic TV screen, or the like.

The conventional preparation of 3D stereoscopic content in movies and broadcast is to stimulate the natural process of the human eyes discussed above in order to create the illusion of depth of the content shown on a planar screen. Referring to FIG. 1(b), the preparation of such content generally requires two cameras (L1, R1) each representing a human eye. Just like the human eyes, the two cameras are placed at the same elevation next to each other at about the same distance apart as the human eyes (i.e., the interocular distance 1) but may be more or less, depending on the shots being captured in order to create two offset images of the captured scene. This variable distance is hereinafter defined as the variable stereo base distance 2 and it assists in conveying the depth of objects shown in the captured scene. When the captured scene is viewed by the viewer through conventional 3D glasses and/or specialized screen, the left-eye offset image is viewed by his left-eye retina, the right-eye offset image is viewed by his right-eye retina, and then his brain combines and processes the two offset images characterized by parallax in order to form a stereoscopic vision of the captured scene.

FIG. 1(c) illustrates the concept of this conventional 3D stereoscopic content process by having a top portion showing real space 300 and a bottom portion showing created stereoscopic space 400. The real space 300 shows the locations of three objects 10, 11, and 12 in nature when they are being recorded by the two cameras (L1 and R1) as described in FIG. 1(b). The created stereoscopic space 400 shows the offset images recorded by the cameras (L1, R1) of the objects 10, 11, and 12 being viewed by the human eyes (L, R). In the real space 300, the left camera L1 and the right camera R1 are separated by the variable stereo base distance 2. To record the objects 10, 11, and 12 in real space 300, the angles 60, 61 of both cameras (L1, R1) are adjusted to horizontal and both cameras (L1, R1) are focused onto the object 11. The corresponding two offset images of objects 10, 11, and 12 recorded by the cameras (L1, R1) are shown in the created stereoscopic space 400 wherein the left eye L and the right eye R are separated by the interocular distance 1. In both of the offset images, object 11 is located at the same location where the planar screen 4 is located (because the cameras L1, R1 were focused on the object 11 in real space 300) requires zero parallaxing of the human eyes (L, R). Accordingly, this mode of viewing object (11) appearing at the location of the screen 4 is defined as zero parallax viewing mode 30. The offset images of the object 10 (10L, 10R) located forward from the screen 4 causes the left eye L to view the offset image 10L located on the right side and the right eye R to view the offset image 10R located on the left side. This action causes both eyes (L, R) to turn excessive inward in order to converge onto them. This type of viewing of the offset images (10L, 10R) appearing in the region located in front of the screen 4 is defined as negative vertical parallax viewing mode 31, unless otherwise state, the vertical direction hereinafter means eyes' advancing direction (z-axis). The offset images of the object 12 (12L, 12R) located backward from the screen 4, causes the left eye L to view the offset image 12L located on the left side and the right eye R to view the offset image 12R located on the right side. This action causes both eyes (L, R) to turn outward in order to converge onto them (12R, 12L). This type of viewing of the offset images (12L, 12R) appearing in the region located in back of the screen 4 is defined as positive vertical parallax viewing mode 32.

The offset images recorded by the cameras (L1, R1) discussed above are displayed as 3D stereoscopic content to the viewer wearing specific 3D glasses and/or specialized screen. Upon receiving the horizontal parallax information provided by these specific 3D glasses and/or specialized screen, the viewer perceives the illusion of 3D stereoscopic vision of such content. When viewing the 3D stereoscopic content, filtered through these glasses or above-mentioned specialized screen, the left-eye image is taking in by the left-eye retina, the right-eye image is taking in by the right-eye retina, the viewer's brain combines and processes the two offset images characterized by horizontal parallax to yield a type of stereoscopic vision and to achieve stereoscopic viewing. Unfortunately, this conventional 3D stereoscopic viewing process can cause some viewers to suffer eyestrain, dizziness, headache, and vomiting due to over parallaxing, excessive convergence and/or divergence. Moreover, the frequent switching between divergence and convergence required of the viewers may also cause them to perceive deformity, distortion and ghosting of the viewed content.

FIG. 1(d) illustrates the phenomenon of left and right eyes (L, R) excessive divergence in the stereoscopic space 400 that occurs when the distance between the offset images (12L, 12R) located in back of the screen 4 exceeds the interocular distance1. This situation causes divergence and forces both eyes (L, R) to each turn too outward resulting in strabismus. It also prevents the viewer's brain from effectively combining the left-eye image 12L and right-eye image 12R of the object 12, and therefore resulting in eyestrain and fatigue.

FIG. 1(e) illustrates the phenomenon of left and right eyes (L, R) excessive convergence in the stereoscopic space 400 that occurs when the converging point of the offset images (10R, 10L) located in front of the screen 4 is too close to both eyes (L, R). This situation causes both eyes to each turn too inward resulting in strabismus. It also prevents the viewer's brain from effectively combining the left-eye image 10L and right-eye image 10R of the object 10, and therefore resulting in eyestrain and fatigue.

Conventional preparation of 3D stereoscopic content is usually divided into pre-production and post-production phases. In the pre-production phase, the two cameras (L1, R1) are used to film the content. In post-production phase, the filmed content is then digitally processed in accordance with the principles of horizontal parallax and stereoscopic vision. Usually, the process involves changing the objects in multi-level of depth of field (usually 4-8 layers) in order to strengthen the 3D stereoscopic effect. This post-production process can also be used to convert 2D content into 3D stereoscopic content.

The above-discussed conventional method to provide 3D stereoscopic content involves substantial expense and effort. Moreover, such content when viewed through conventional 3D glasses and/or specialized screen can still provide stratified distortion and is unable to duplicate the depth perception that can be perceived by the human eyes. In nature, the depth perception of the pictured scene is a continuous natural extension with an infinite amount of depth layer partitioning of such scene. As noted above, the conventional method can result in excessive convergence or divergence causing some viewers to experience eyestrain, visual fatigue, dizziness, headache, and even vomiting.

### SUMMARY OF INVENTION

The present invention solves the above-mentioned issues and provides optical stereoscopic glasses that establish 3D stereoscopic vision when viewing 2D content on a planar screen. The present invention includes adjustable optical glasses comprising: a housing, a left lens assembly and a right lens assembly wherein: (a) when a 2D image shown on a planar screen is viewed by left eye of a viewer through the left lens assembly, the left lens assembly induces the left eye to perceive a left eye offset image of the 2D image which appears to be located at a different spatial location than actual physical location of the 2D image shown on the planar screen in real space; (b) when a 2D image shown on a planar screen is viewed by right eye of the viewer through the right lens assembly, the right lens assembly induces the right eye to perceive a right eye offset image of the 2D image which appears to be located at a different spatial location than actual physical location of the 2D image shown on a planar screen in real space; (c) a spatial difference exists between perceived location of the left eye offset image by the left eye and perceived location of the right eye offset image by the right eye; (d) the left eye offset image and the right eye offset image created by the glasses fall within at least one of the following viewing modes: positive parallax hyperstereo viewing mode; positive parallax hypostereo viewing mode; negative parallax hyperstereo viewing mode and negative parallax hypostereo viewing mode, which causes the viewer to perceive the 2D image shown on the planar screen as 3D stereoscopic image. The present invention uses the glasses to provide the viewer with 3D stereoscopic vision of the 2D content shown on the planar screen. The 2D content can be any conventional images and is not required to undergo conventional 3D stereoscopic content processing discussed above.

### BRIEF DESCRIPTION OF THE DRAWINGS

The features and inventive aspects of the present invention will become more apparent upon reading the following detailed description, claims, and drawings, of which the following is a brief description.

FIG. 1(a) illustrates the interocular distance of stereoscopic version of human eyes;

FIG. 1(b) illustrates the variable of stereo base distance of two cameras;

FIG. 1(c) illustrates a viewing mode relating to vertical parallax;

FIG. 1(d) illustrates a viewing mode relating to excessive divergence;

FIG. 1(e) illustrates a viewing mode relating to excessive convergence;

FIG. 2(a) illustrates the different viewing modes when the variable stereo base distance is varied;

FIG. 2(b) illustrates the different viewing modes when the point of convergence is varied;

FIG. 3 illustrates the viewing mode involving a Galilean telescope;

FIG. 4(a) illustrates a back view of an embodiment of an adjustable optical stereoscopic glasses of the present invention;

FIG. 4(b) illustrates a left side view of the optical stereoscopic glasses shown in FIG. 4(a);

FIG. 4(c) illustrates a front view of the optical stereoscopic glasses shown in FIG. 4(a);

FIG. 4(d) illustrates a right side cross-section view of the optical stereoscopic glasses shown in FIG. 4(a);

FIG. 5 issues a perspective view of the optical stereoscopic glasses shown in FIG. 4(a);

FIG. 6 illustrates a top cross-sectional view of one type of the optical stereoscopic glasses shown in FIG. 4(a);

FIG. 7 illustrates the numbers of optical elements of the left and right lens assemblies of the optical stereoscopic glasses shown in FIG. 4(a);

FIG. 8(a) illustrates a positive parallax hyperstereo viewing mode;

FIG. 8(b) illustrates a negative parallax hyperstereo viewing mode;

FIG. 8(c) illustrates a positive parallax hypostereo viewing mode;

FIG. 8(d) illustrates a negative parallax hypostereo viewing mode;

FIG. 9(a) illustrates a viewing mode when viewing a planar screen through a rectangular prism that is angled to the horizontal axis;

FIG. 9(b) illustrates a viewing mode when viewing a planar screen through another rectangular prism that is angled to the horizontal axis;

FIG. 10 illustrates a positive parallax hyperstereo viewing mode when viewing a planar screen through rectangular prisms that are angled relative to a horizontal axis;

FIG. 11 illustrates a positive parallax hypostereo viewing mode when viewing a planar screen through rectangular prisms that are angled relative to a horizontal axis;

FIG. 12 illustrates a viewing mode when viewing a planar screen through a triangular prism;

FIG. 13 illustrates a viewing mode when viewing a planar screen through another triangular prism;

FIG. 14 illustrates difference between two viewing modes based upon the amount of separation space between two triangular prisms;

FIG. 15 illustrates a zero vertical parallax hyperstereo viewing mode when viewing a planar screen through an embodiment of the left lens assembly and the right lens assembly of the optical stereoscopic glasses of the present invention;

FIG. 16 illustrates a zero vertical parallax hypostereo viewing mode when viewing a planar screen through an embodiment of the left lens assembly and the right lens assembly of the optical stereoscopic glasses of the present invention;

FIG. 17 illustrates a positive parallax hyperstereo viewing mode when viewing a planar screen through an embodiment of the left lens assembly and the right lens assembly of the optical stereoscopic glasses of the present invention having six triangular prisms;

FIG. 18 illustrates a positive parallax hypostereo viewing mode when viewing a planar screen through an embodiment of the left lens assembly and the right lens assembly of the optical stereoscopic glasses of the present invention having six triangular prisms;

FIG. 19 illustrates a positive parallax hyperstereo viewing mode when viewing a planar screen through another embodiment of the left lens assembly and the right lens assembly of the optical stereoscopic glasses of the present invention having six triangular prisms;

FIG. 20 illustrates a positive parallax hypostereo viewing mode when viewing a planar screen through another embodiment of the left lens assembly and the right lens assembly of the optical stereoscopic glasses of the present invention having six triangular prisms;

FIG. 21 illustrates a positive parallax hyperstereo viewing mode when viewing a planar screen through an embodiment of the left lens assembly and the right lens assembly of the optical stereoscopic glasses of the present invention having eight triangular prisms;

FIG. 22 illustrates a positive parallax hypostereo viewing mode when viewing a planar screen through an embodiment of the left lens assembly and the right lens assembly of the optical stereoscopic glasses of the present invention having eight triangular prisms;

FIG. 23 illustrates a positive parallax hyperstereo viewing mode when viewing a planar screen through another embodiment of the left lens assembly and the right lens assembly of the optical stereoscopic glasses of the present invention having eight triangular prisms; and

FIG. 24 illustrates a positive parallax hypostereo viewing mode when viewing a planar screen through another embodiment of the left lens assembly and the right lens assembly of the optical stereoscopic glasses of the present invention having eight triangular prisms.

### DETAILED DESCRIPTION OF THE INVENTION

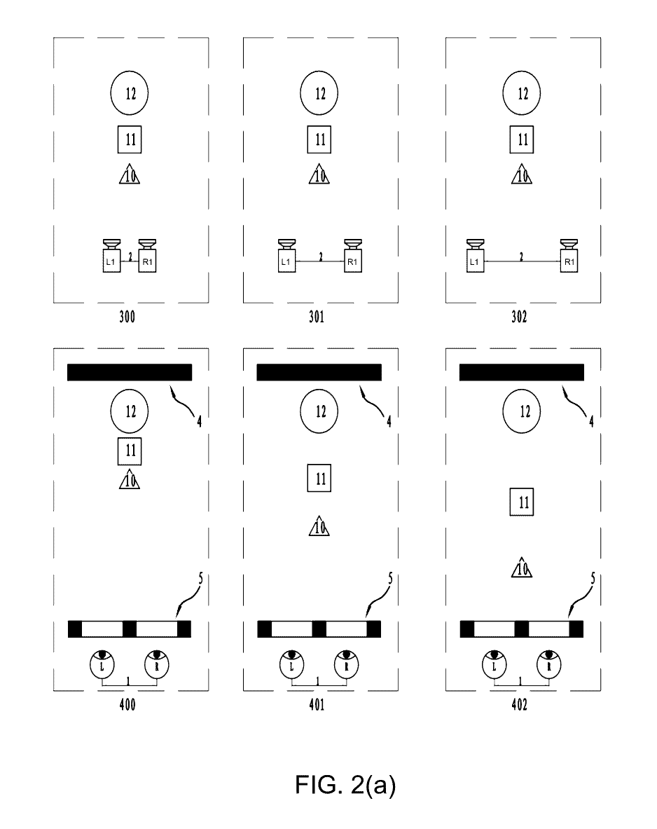

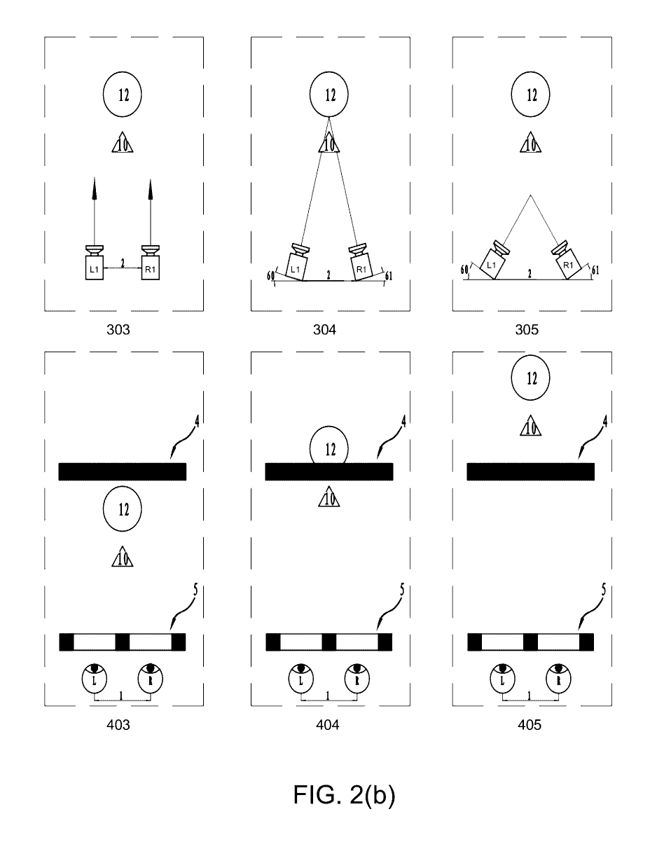

FIG. 2(a) illustrates how adjusting the variable stereo base distance 2 between the two cameras (L1, R1) can dynamically change the depth of the 3D stereoscopic content provided by the screen 4. FIG. 2(a) shows three viewing modes comprising of real space 300, 301, 302 and their respective created stereoscopic space 400, 401, and 402. In real space 300, 301, 302, two cameras (L1 and R1) separated by different variable stereo base distance 2 are used to capture images of three objects (10, 11, 12). The captured images of the three objects (10, 11, 12) as seen by a viewer's left eye L and right eye R through optical stereoscopic glasses 5 are shown in their respective created stereoscopic space 400, 401, 402 viewing modes. FIG. 2(a) shows that there is a direct relationship between the length or distance of the variable stereo base distance 2 and the depth perspective of the images of the three objects (10, 11, 12). For example, the variable stereo base distance 2 between the two cameras (L1, R1) depicted in the real space 300 is shorter than the variable stereo base distance 2 between the two cameras (L1, R1) depicted in the real space 301. The same relationship is true for the depth perspective of the images of the three objects (10, 11, 12) in their respective created stereoscopic spaces (400, 401). The depth perspective of the images of the three objects (10, 11, 12) is reduced in the created stereoscopic space 400 when compared to the depth perspective of the images of the three objects (10, 11, 12) in the created stereoscopic space 401. This direct relationship between the length or distance of the variable stereo base distance 2 and the depth perspective of the images of the three objects (10, 11, 12) is also shown in comparing real space 301 and 302 and their respective created stereoscopic space 401 and 402. Accordingly, increasing the variable stereo base distance 2 in real space will result in increasing the depth perspective of three images in created stereoscopic space.

FIG. 2(b) illustrates how adjusting convergence will change the vertical parallax effect of the stereoscopic images of the objects shown by the screen 4. FIG. 2(b) shows (i) real space 303, 304, 305 each has the two cameras (L1, R1) separated by different variable stereo base distance 2 recording two objects (10, 12); and (ii) their respective created stereoscopic space 403, 404, 405 viewing modes of the images of the two objects (10, 12) shown by the screen 4 viewed by both eyes (L, R) using the glasses 5. To increase convergence, the two cameras (L1, R1) are angled (60, 61) toward each other. By increasing convergence (e.g., the degree in which the two cameras (L1, R1) are angled toward each other (60, 61) in real space, the images of the objects 10, 12 are moved in a direction from front of the screen 4 toward back of the screen 4 as shown in FIG. 2(b). In the real space 303, the cameras (L1, R1) are not angled and parallel to each other. Its respective created stereoscopic space 403 shows the images of the two objects (10, 12) are located in front of the screen. In the real space 304, the cameras (L1, R1) are angled to a predetermined degree (60, 61) relative to a horizontal axis. Its respective created stereoscopic space 404 shows the images of the two objects (10, 12) are located around the location of the screen 4. In the real space 305, the cameras (L1, R1) are angled to a predetermined degree (60, 61) relative to a horizontal axis that is greater than the predetermined degree used in the real space 304. Its respective created stereoscopic space 405 shows the images of the two objects (10, 12) are located behind the location of the screen 4.

Binocular disparity and spatial parallax are the most important factors for providing proper 3D stereoscopic vision. The present invention presents optical stereoscopic glasses that can provide 3D stereoscopic vision when viewing 2D content on a planar 2D surface (hereinafter referred to as “planar screen”) such as a book or a screen such as a movie screen, a television screen, a computer screen, a tablet screen, a phone screen, a gaming console screen, or the like. When utilizing the glasses to watch 2D image on the planar screen, it is able to induce the viewer's brain to yield depth perception of spatial field and restore the continuous extension of the nature space, generate 3D stereoscopic vision and view along with continuous depth field of space. The glasses not only solve the technical issue of multi-layer depth of space but also negate the required preparation of 3D stereoscopic content for viewing.

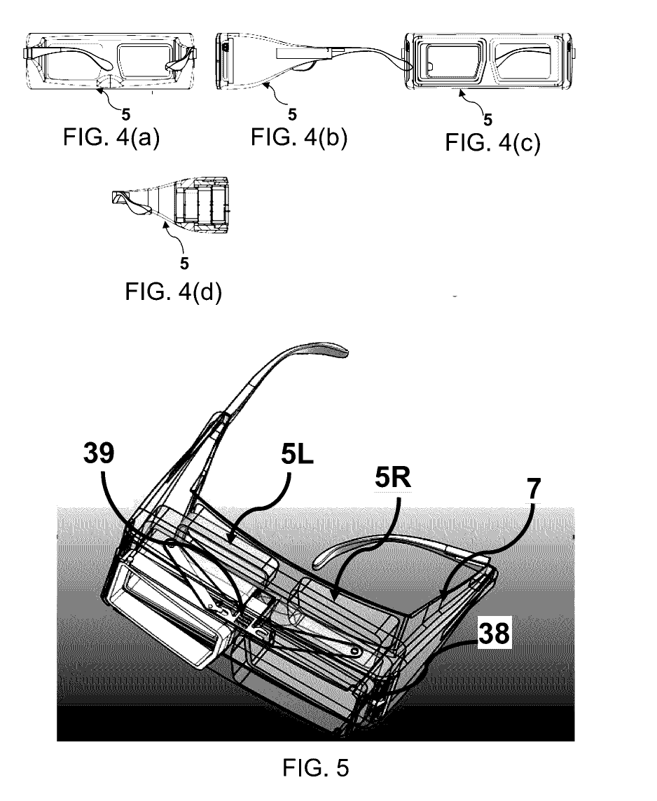

Referring to FIGS. 4(a)-4(d), 5 and 6, the glasses 5 includes a housing 7, a left lens assembly 5L and a right lens assembly 5R wherein the housing 7 is designed and configured to be worn as eye glasses by a viewer. Each of the left lens assembly 5L and the right lens assembly 5R is comprised of one or more optical prisms, lenses, curved mirrors, planar mirrors, and a combination thereof (hereinafter referred to as “optical element(s)”). The optical element(s) can be constructed of any suitable material such as optical glass, plastic, colloidal and other lightweight, high transparency, high refractive index optical materials, including but not limited to solid, liquid, colloidal and other medium or combinations of them. In one embodiment, the optical element(s) are comprised of a combination of plane prism and triangular prism collocation. In an effort to avoid image distortion, it is preferred that the optical element(s) have the following characteristics: no diopter, no color difference and a vertex angle is not too large.

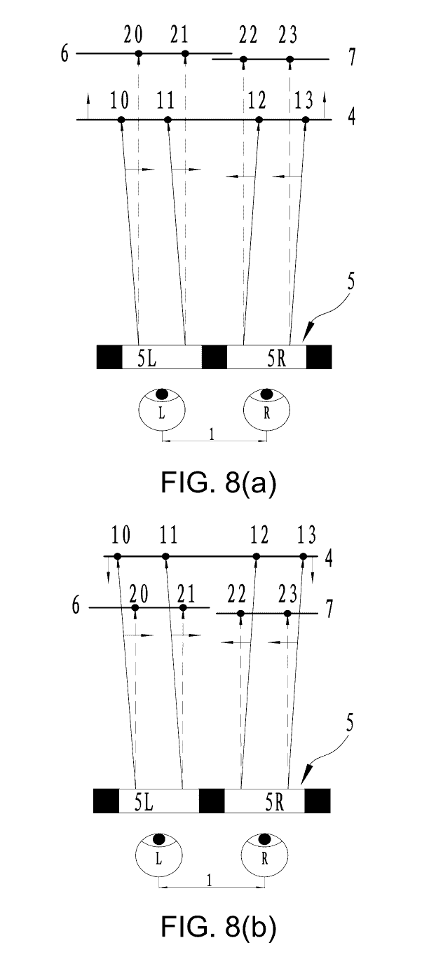

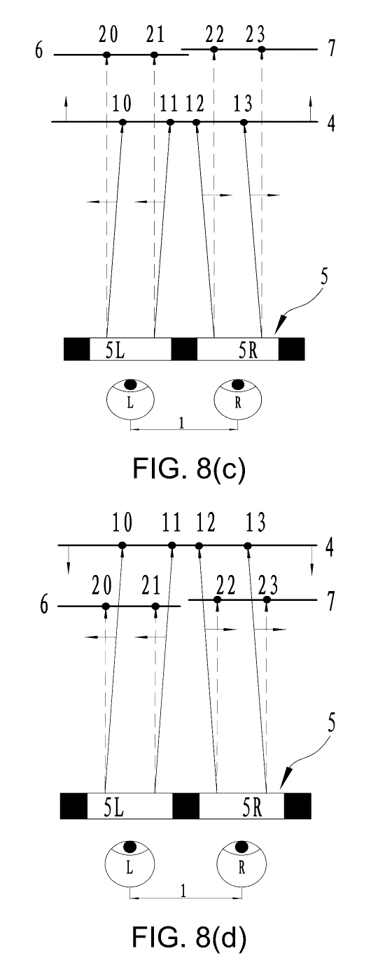

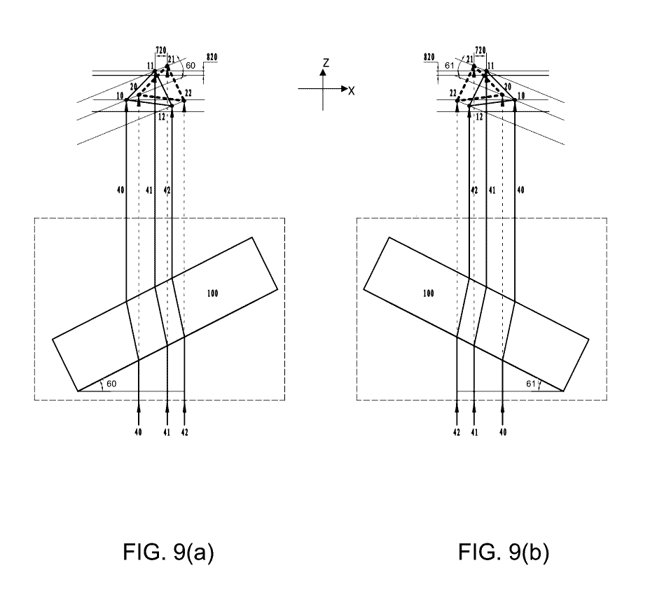

The one or more optical elements provide refraction which represents deflection of the viewing pathway that causes spatial displacement of the viewed 2D image. The refraction of the optical elements of the two lens assemblies (5L, 5R) create each of the four viewing modes illustrated in FIGS. 8(a)-(d) that can provide 3D stereoscopic vision of 2D content shown on a planar screen. Optimal fusing of parallax is achieved by adjusting refraction of the optical elements. The glasses 5 eliminate the negative effect to 3D stereoscopic vision by zero parallax when focusing on a planar screen. When viewing 2D content shown on the planar screen 4 using the glasses 5, the glasses 5 provide a left eye offset image and a right eye offset image. The left eye offset image, characterized by spatial displacement, is viewed and perceived by the viewer's left eye retina, and the right eye offset image, characterized by spatial displacement, is also viewed and perceived by the viewer's right eye retina. The viewer's brain combines and processes these two offset images containing the specific difference discussed herein that resulted in spatial parallax in order to form a continuous and natural feeling 3D stereoscopic vision.

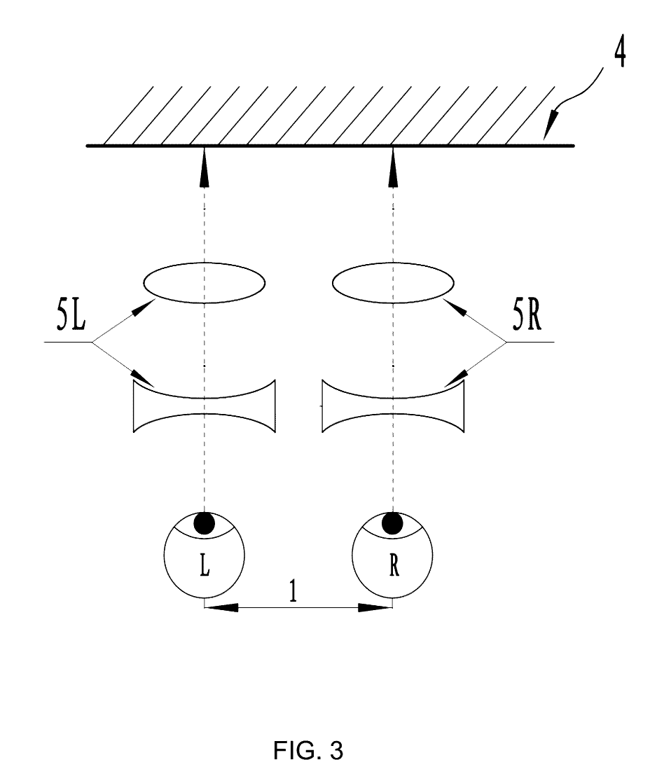

The difference between 2D content viewing wherein each objective point of a 2D image has a horizontal (x) axis point, a perpendicular (y) axis point, and a vertical (z) axis point on the screen 4 wherein the vertical (z) axis point has the same location as the vertical (z) axis point of the screen 4 in real space; and 3D stereoscopic content viewing is that the spatial depth (i.e., variation in location on the vertical axis) is not available for the 2D content shown on the planar screen 4. With 3D stereoscopic vision in nature, both convergence point and focal point fall onto the object and the existing binocular disparity informs brain that the object's 3D location coordinates in the real space. Viewing 2D content shown on the screen 4, both the convergence point and focal point fall onto the object on the screen plane and zero vertical parallax informs brain that the object has only 2D location coordinates in the planar space. Even though the viewer's brain sense that depth may exists in specific format such as space perspective, relative motion and motion disparity, it cannot avoid the strong feeling induced by zero parallax that the viewing is planar viewing so it does not recognize such viewing as 3D. Basically, the brain is unwilling to perceive any 2D content shown on the screen 4 as 3D due to the lack of binocular disparity when focusing on plane screen 4; which shall hereinafter be referred to as the “planar view effect”. This planar view effect can be reduced or even eliminated by parallax when focusing on 2D content shown on the planar screen 4. For example, as illustrated in FIG. 3, the lens assemblies (5L, 5R) can include optical elements similar to the ones used in a Galilean telescope to view a 2D content shown on the planar screen 4 by the viewer's eyes (L, R) separated by the interocular distance 1. The optical elements of the lens assemblies (5L, 5R) provides the desired virtual image which reduces or even eliminates the planar view effect and induces the viewer to perceive 3D stereoscopic vision of such content.

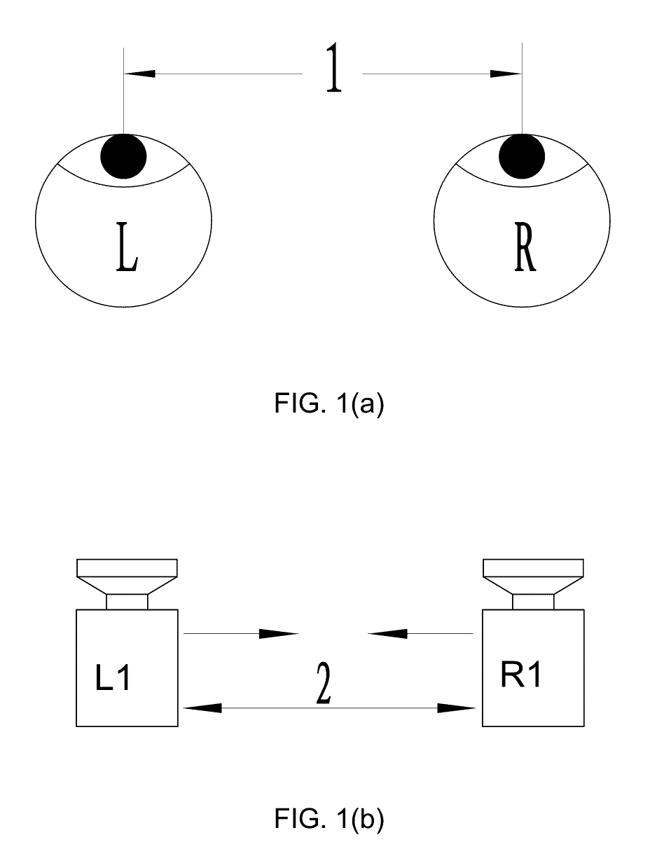

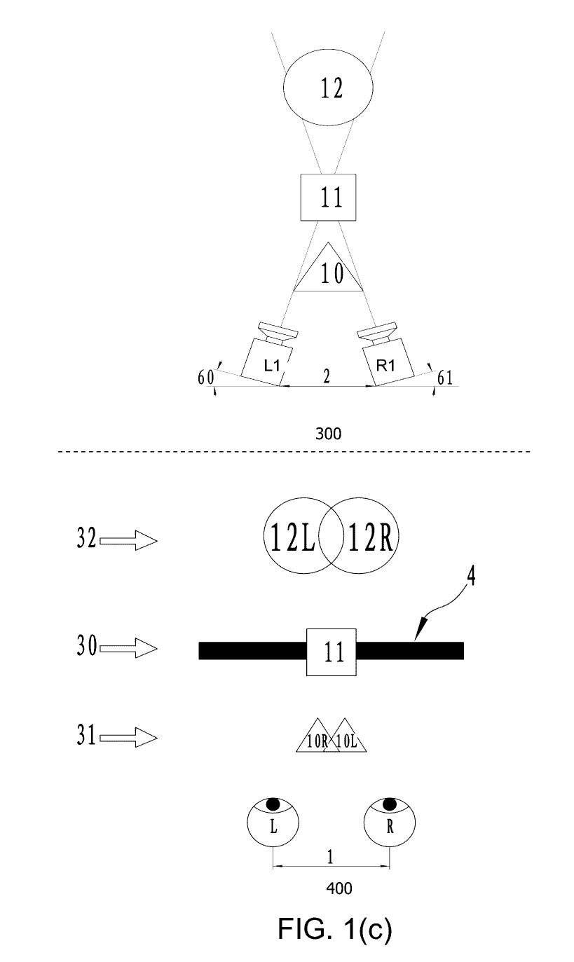

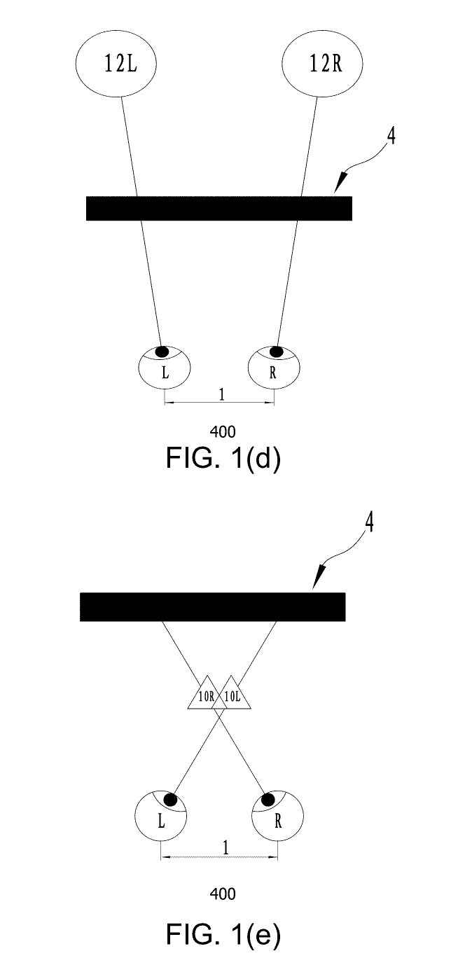

In an effort to provide comfortable stereoscopic viewing of 2D content on the screen 4 which reduces eye fatigue especially during long period of stereoscopic viewing, it is preferred that the lens assemblies (5L, 5R) of the glasses 5 are structured to simulate the variable stereo base distance 2 that realizes a viewing mode with appropriate depth such as the one illustrated in the real space 301 and its respective created stereoscopic space 401 of FIG. 2(a). It is also preferred that the lens assemblies (5L, 5R) provides a convergence point to form a positive parallax such as the viewing mode illustrated in in the real space 301 and its respective created stereoscopic space 401 of FIG. 2(b). Moreover, it is desired that the lens assemblies (5L, 5R) provide an appropriate adjustment range of binocular convergence for the desired varying degrees of parallax in order to meet the needs of a broad spectrum of viewers. It is also desired that the lens assemblies (5L, 5R) avoid providing viewing modes that cause the viewer's eyes to turn either excessively outwards due to excessive divergence as illustrated in FIG. 1(d) or excessively inwards due to excessive convergence as illustrated in FIG. 1(e).

The housing 7 is used to house or contain the left lens assembly 5L and the right lens assembly 5R. The glasses 5 achieve the desired 3D stereoscopic vision using at least one of the following viewing modes: positive parallax hyperstereo viewing mode, positive parallax hypostereo viewing mode, negative parallax hyperstereo viewing mode, and negative parallax hypostereo viewing mode. Each of these viewing modes is discussed in detailed below and illustrated in FIGS. 8(a)-8(d).

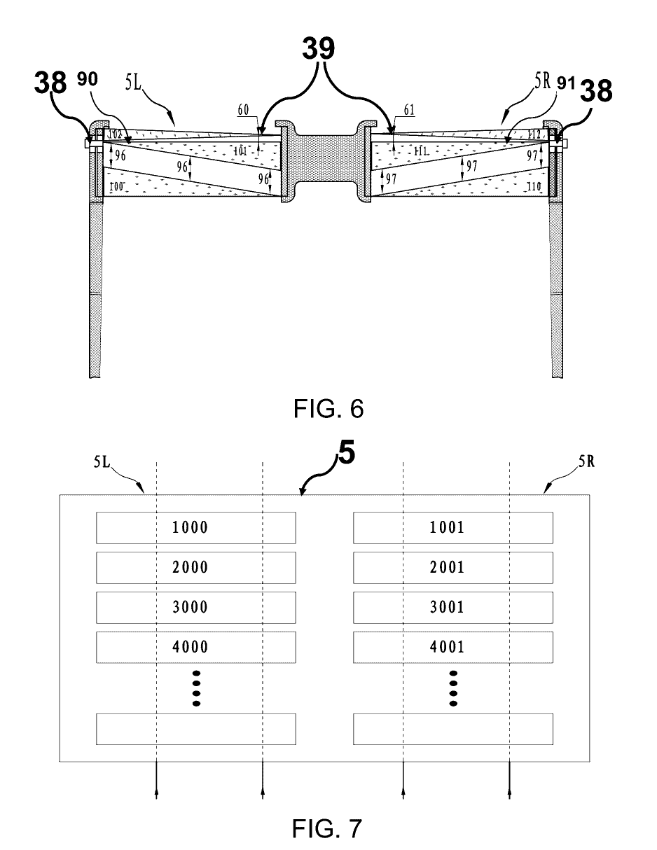

In one embodiment of the glasses 5 and referring to FIG. 6, the optical elements of the left lens assembly 5L include an exterior triangular lens 102, an inner triangular lens 101 and an interior triangular lens 100 forming a composite structure containing separation spaces 90, 96. Similarly, the optical elements of the right lens assembly 5R also include an exterior triangular lens 112, an inner triangular lens 111, an interior triangular lens 110 creating a composite structure containing separation spaces 91, 97. This embodiment further optionally includes adjustment mechanism 38 for each of the lens assemblies (5L, 5R) to adjust the separation space (96, 97) located within each lens assembly (5L, 5R) in order to realize spatial parallax adjustment. This embodiment further optionally includes adjustment mechanism 39 for each of the lens assemblies (5L, 5R) to adjust the angle (60, 61) of the outer one or more of the optical elements within each lens assembly (5L, 5R) in order to realize spatial parallax adjustment. Adjustment(s) to the horizontal parallax and vertical parallax allows the glasses 5 to reach appropriate binocular parallax effect and to weaken the negative effect of zero parallax when converging on the planar screen 4.

The adjustment mechanism 38 include a feature, preferably located on each side of the frame adjacent to each lens assembly (5L, 5R), that can move within an axis (e.g., up and down direction) in order to change the amount of the separation space (96, 97). For example, the adjustment mechanism 38 shown in FIG. 6 can be used to change the amount of the separation space (96, 97) between the inner triangular lens (100, 101). Moreover, The adjustment mechanism 39 include a feature, preferably located on top of the housing 7 of the glasses 5, that can optionally move within an axis (e.g., back and forth direction) and change the angle of the outer optical elements within each of the lens assembly (5L, 5R). The adjustment mechanism 39 shown in FIG. 6 can change the variable angle (60, 61) of the exterior triangular lens (102, 112) in order to realize the adjustment of spatial displacement of imaging screen and convergence point. When the separation space (96, 97) between the inner triangular lens (100, 101) and (110, 111) is changed to zero by the adjustment mechanism 38, the combination of the inner triangular lens (100, 101) and (110, 111) become a rectangular prism structure. Under this circumstance, the variable angles (60, 61) of each of the exterior triangular lens (102, 112) are used to fine-tune the spatial displacements of the imaging screen plane and the convergence point.

FIG. 7 is schematic diagram of the left lens assembly 5L and the right lens assembly 5R of the present invented 3D stereoscopic glasses. Each optical element of the left lens assembly (5L) is shown separately as 1000, 2000, 3000, 4000 . . . . Each optical element of the right lens assembly (5R) is shown separately as 1001, 2001, 3001, 4001 . . . . The number of optical elements within each lens assembly (5L, 5R) may range from 0 up to 100 based upon desired commercial applications and requirements. It should be noted that the number of optical elements for the left lens assembly 5L and the right lens assembly 5R cannot be zero at the same time.

FIGS. 8(a)-8(d) illustrate four stereoscopic viewing modes used by the glasses 5 to achieve 3D stereoscopic vision of a 2D image shown on the planar screen 4. In each of these modes, the left eye L and the right eye R, separated by the interocular distance 1, is viewing the 2D image on the planar screen 4 using the glasses 5 comprising the left lens assembly 5L and the right lens assembly 5R. When the left eye L views the 2D image through the left lens assembly 5L, it (L) perceives the 2D image to be located at left eye image plane 6. When the right eye R views the 2D image through the right lens assembly 5R, it (R) perceives the 2D image to be located at right eye image plane 7. The image points 10-13 are specific objective points or portions of the 2D image shown on the screen 4 at specific locations. The image point 20 is a specific point on the left eye image plane 6 viewed by the left eye through the left lens assembly 5L that corresponds to the objective point 10. The image point 21 is a specific point on the left eye image plane 6 viewed by the left eye through the left lens assembly 5L that corresponds to the objective point 11. The image point 22 is a specific point on the right eye image plane 7 viewed by the right eye through the right lens assembly 5R that corresponds to the objective point 12. The image point 23 is a specific point on the right eye image plane 7 viewed by the right eye through the right lens assembly 5R that corresponds to the objective point 13.

FIG. 8(a) illustrates a positive parallax hyperstereo viewing mode of the present invention involving both horizontal parallax and vertical parallax. In this mode, the left eye image plane 6 and the right eye image plane 7 are located in back of (or backward from) the screen 4 resulting in backward vertical displacement for both eyes (L, R). The left eye image plane 6 and the right-eye image plane 7 can but does not need to have the same vertical (z) axis coordinate/location. Moreover, the image points 10, 11 on the screen 4 viewed by the left eye L has been horizontally displaced to the right as shown by the image points 20, 21 on the left eye image plane 6. The image points 12, 13 on the screen 4 viewed by the right eye R has been horizontally displaced to the left as shown by the image points 22, 23 on the right eye image plane 7.

FIG. 8(b) illustrates a negative parallax hyperstereo viewing mode of the present invention involving both horizontal parallax and vertical parallax. In this mode, the left eye image plane 6 and the right eye image plane 7 are located in front of (or forward from) the screen 4 resulting in forward vertical displacement for both eyes (L, R). The left eye image plane 6 and the right-eye image plane 7 can but does not need to have the same vertical (z) axis coordinate/location. Moreover, the image points 10, 11 on the screen 4 viewed by the left eye L has been horizontally displaced to the right as shown by the image points 20, 21 on the left eye image plane 6. The image points 12, 13 on the screen 4 viewed by the right eye R has been horizontally displaced to the left as shown by the image points 22, 23 on the right eye image plane 7.

FIG. 8(c) illustrates a positive parallax hypostereo viewing mode of the present invention involving both horizontal parallax and vertical parallax. In this mode, the left eye image plane 6 and the right eye image plane 7 are located in back of (or backward from) the screen 4 resulting in backward vertical displacement for both eyes (L, R). The left eye image plane 6 and the right-eye image plane 7 can but does not need to have the same vertical (z) axis coordinate/location. Moreover, the image points 10, 11 on the screen 4 viewed by the left eye L has been horizontally displaced to the left as shown by the image points 20, 21 on the left eye image plane 6. The image points 12, 13 on the screen 4 viewed by the right eye R has been horizontally displaced to the right as shown by the image points 22, 23 on the right eye image plane 7.

FIG. 8(d) illustrates a negative parallax hypostereo viewing mode of the present invention involving both horizontal parallax and vertical parallax. In this mode, the left eye image plane 6 and the right eye image plane 7 are located in front of (or forward from) the screen 4 resulting in forward vertical displacement for both eyes (L, R). The left eye image plane 6 and the right-eye image plane 7 can but does not need to have the same vertical (z) axis coordinate/location. For example either image plane 6 can be located vertically in front of image plane 7 or vice versa. Moreover, the image points 10, 11 on the screen 4 viewed by the left eye L has been horizontal displaced to the left as shown by image point 20, 21 on the left eye image plane 6. The image points 12, 13 on the screen 4 viewed by the right eye R has been horizontal displaced to the right as shown by image point 22, 23 on right eye image plane 7.

The positive parallax hyperstereo viewing mode as illustrated by FIG. 8(a) is the most preferred viewing mode. The positive parallax hypostereo viewing mode as illustrated by FIG. 8(c) is the next preferred viewing mode. This mode could be used when the size of the image is properly restricted; otherwise, visual divergence as illustrated in FIG. 1(d) may occur resulting in excessive outward eyes squint. The negative parallax hyperstereo viewing mode as illustrated in FIG. 8(b) is the next preferred viewing mode after the positive parallax hypostereo viewing mode. This mode could be used when the image is properly restricted for less near objects, otherwise, visual convergence as illustrated in FIG. 1(e) may occur resulting in excessive inward eyes squint. The negative parallax hypostereo viewing mode as illustrated in FIG. 8(d) is the least preferred viewing mode. It could only be used when the size of the image and the near objects is properly restricted, otherwise, visual divergence and convergence as illustrated in FIG. 1(d) may occur resulting in excessive outward eyes squint and visual convergence as illustrated in FIG. 1(e) may also occur resulting in excessive inward eyes squint.

Extreme manifestations of the viewing modes illustrated in FIGS. 8(a)-8(d) occur when the left lens assembly is providing the desired image for the predetermined viewing mode but not the right lens assembly, in that the image points 12, 13 coincide with the imaging points 22, 23 resulting in zero spatial parallax (i.e., both horizontal parallax and vertical parallax are zero). In this situation, the left eye is properly viewing through the left lens assembly but the right eye is same as naked viewing without using lenses. Similarly, it can also occur when the right lens assembly is providing the desired image for the predetermined viewing mode but not the left lens assembly, in that the image points 10, 11 coincide with the imaging points 20, 21 resulting in zero spatial parallax. In this situation, the left eye is same as naked viewing without using lenses.

When viewing 2D content on a planar screen using the glasses 5, the image takes place spatial displacement, which follows one of the viewing modes illustrated in FIGS. 8(a)-8(d). It is preferred that diopter is not provided by the optical element(s) of the lens assemblies (5L, 5L) because it may cause chromatic aberration, dispersion and deformity phenomenon resulting in visual fatigue especially during long viewing periods. Prisms and plane mirrors do not have diopter. Accordingly, prism(s), plane mirror(s), or a combination thereof are generally the preferred optical elements over optical lenses and/or curved mirror(s).

In one embodiment of the glasses 5, the optical elements of each of the lens assemblies (5L, 5R) comprise a collection of prisms. Since a collection of prisms generally occupies less physical space than a collection of plane mirrors, it is preferred. Furthermore, in order to reduce the thickness of the glasses 5, it is preferred that the optical element be made thinner is possible. For example, a thin prism having a relatively large refractive index may be a suitable choice. However, it should be noted that a large refractive index would produce dispersion. To reduce the dispersion effect, various means can be used such as mixing different refractive index of prism and/or different vertex angles in order to equalize for each other.

When each of the lens assemblies (5L, 5R) is comprised of a plurality of prisms providing separating and filtering functions to stray lights resulting in the glasses 5 providing the additional benefit of providing a more colorful, brighter and sharper 3D stereoscopic image compared to viewing with the naked eyes. The naked eyes are affected seriously by background stray light when compared to viewing through such lens assemblies (5L, 5R) of the glasses 5.

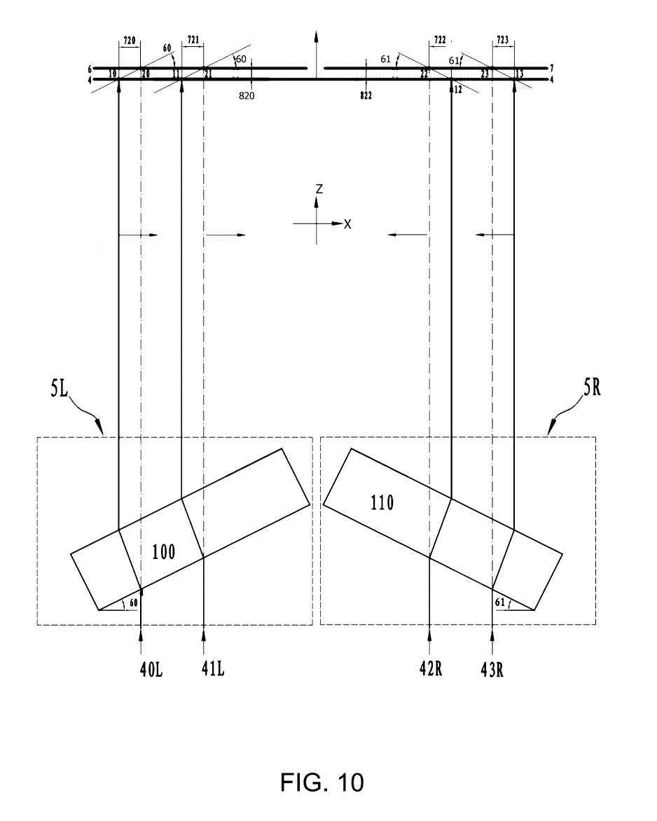

As discussed above, the viewing modes illustrated in FIGS. 8(a)-8(d) are achieved by the lens assemblies (5L, 5R) comprising of various optical elements. Exemplary embodiments of the lens assemblies (5L, 5R) are discussed below and illustrated in FIGS. 10-11 and 15-24.

Referring to FIGS. 9(a) and 9(b), the optical element of an angled rectangular prism 100 of the glasses 5 causes deflection of the viewer's viewing pathway of a 2D image in order to provide the desired parallax needed to induce 3D stereoscopic vision of such image. As shown in FIG. 9(a)-9(b), the optical element 100 is a rectangular prism angled at a predetermined degree either count-clockwise 60 or clockwise 61 to the horizontal axis. When viewed three objective points 10, 11, 12 through the optical element 100, their viewing pathways 40, 41, 42 are deflected due to refraction by the optical element 100 resulting in spatial displacements as shown by corresponding image points 20, 21 and 22. The spatial displacements include the horizontal displacement 720 and the vertical displacement 820. These spatial displacements caused by the angled rectangular prism 100 indicate that it can function as the optical element of each of the lens assemblies (5R, 5L) of the glasses 5 in order to fulfill the functionality requirement by the viewing modes shown in FIGS. 8(a)-8(d). Unless stated otherwise herein, a rectangular prism hereinafter is defined by the two main optical planes parallel to each other.

Pursuant to fundamental optical theory, to view an object through the rectangular prism 100, the following scenarios can occur. When a light path is perpendicular to the rectangular prism 100 (which means that the angle 60 in FIG. 9(a) equals either 0 or 180 degrees), no deflection occurs. When the angle 60 is greater than 0 but less than 90 degree, the generated refraction causes the horizontal displacement shifted to the right and vertical displacement shifted backward as illustrated in FIG. 9(a). When the angle 60 is greater than 90 degree but less than 180 degree, the generated refraction causes the horizontal displacement shifted to the left and the vertical displacement shifted backward.

Referring to FIG. 10 and in this embodiment, the left lens assembly (5L) includes optical element 100 which sets an angle 60 count-clockwise to a horizontal axis and the right lens assembly (5R) includes optical element 110 which sets an angle 61 clockwise to a horizontal axis. When viewed a 2D image shown on planar screen 4 through the lens assemblies (5L, 5R), the objective points 10, 11 on the screen 4 viewed by the left eye L has been horizontal displaced 720, 721 to the right as shown by image point 20, 21 on the left eye image plane 6. The objective points 12, 13 on the screen 4 viewed by the right eye R has been horizontal displaced 722, 723 to the left as shown by image point 22, 23 on right eye image plane 7. The left eye image plane 6 and the right eye image plane 7 are located in back of (or backward from) the screen 4 resulting in backward vertical displacement 820, 822 for both eyes (L, R). Accordingly, this embodiment provides a positive parallax hyperstereo viewing mode as illustrated in FIG. 8(a).

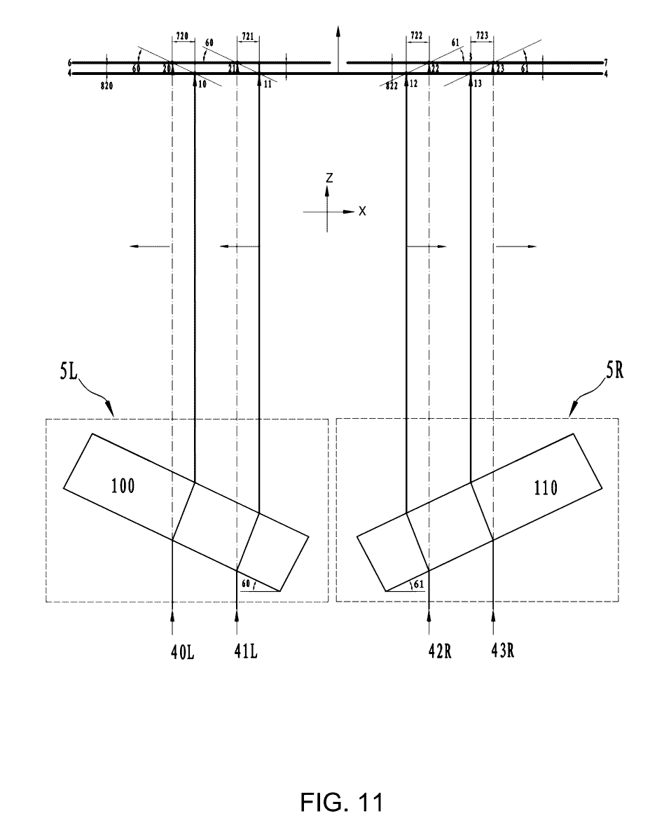

Referring to FIG. 11 and in this embodiment, the left lens assembly (5L) includes optical element 100 which sets an angle 60 clockwise to a horizontal axis and the right lens assembly (5R) includes optical element 110 which sets an angle 61 count-clockwise to horizontal. When viewed a 2D image shown on planar screen 4 through the lens assemblies (5L, 5R), the objective points 10, 11 on the screen 4 viewed by the left eye L has been horizontal displaced 720, 721 to the left as shown by image point 20, 21 on the left eye image plane 6. The objective points 12, 13 on the screen 4 viewed by the right eye R has been horizontal displaced 722, 723 to the right as shown by image point 22, 23 on right eye image plane 7. The left eye image plane 6 and the right eye image plane 7 are located in back of (or backward from) the screen 4 resulting in backward vertical displacement 820, 822 for both eyes (L, R). Accordingly, this embodiment provides a positive parallax hypostereo viewing mode as illustrated in FIG. 8(c).

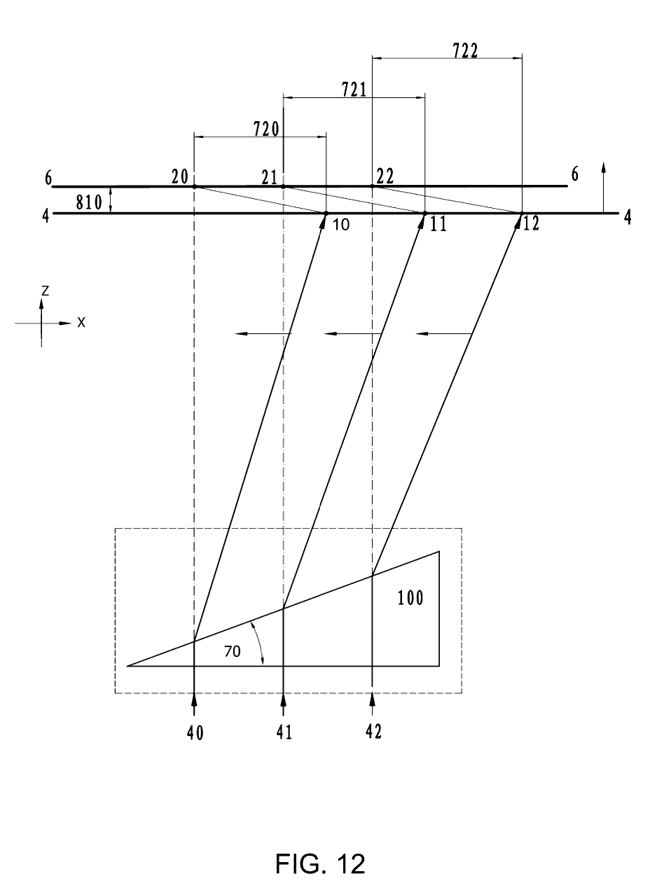

Referring to FIG. 12, the optical element 100 is a triangular prism with a vertex angle 70 placed along a horizontal axis. When viewed three objective points 10, 11, 12 of a 2D image shown on the planar screen 4, through the optical element 100, due to refraction, the viewing pathways 40, 41, 42 experienced spatial deflection shown by respective image points 20, 21, 22 of the image plane 6. The spatial displacement includes the horizontal displacement 720, 721, 722 to the left and the vertical displacement 820 backward.

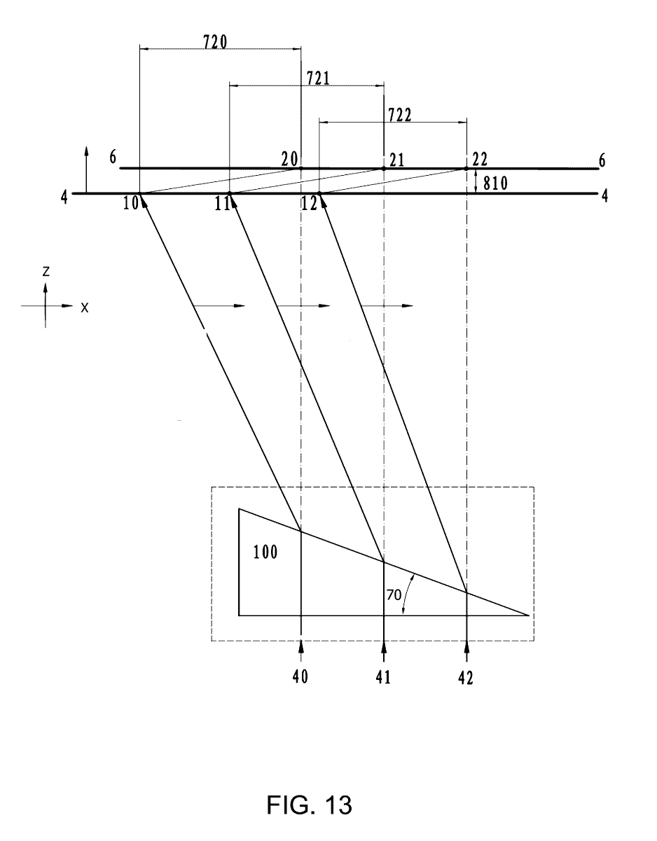

Referring to FIG. 13, the optical element 100 is a triangular prism with vertex angle 70 that is a mirror image of the triangular prism illustrated in FIG. 12. When viewed three objective points 10, 11, 12 of a 2D image shown on the planar screen 4, through the optical element 100, due to refraction, the viewing pathways 40, 41, 42 experienced spatial defection shown by respective image points 20, 21, 22 of the image plane 6. The spatial displacement includes the horizontal displacement 720, 721, 722 shifted to the right and the vertical displacement 820 shifted backward.

Unless otherwise stated, a triangular prism is hereinafter defined as the two main optical planes or extension cross a vertex angle as illustrated in FIGS. 12 and 13. The spatial displacements achieved by the triangular prism 100 shown in FIGS. 12-13 indicate that an angled triangular prism to the horizontal axis can be used as an optical element for each of the lens assemblies (5L, 5R) of the glasses 5 to fulfill the functionality requirements by the viewing modes shown in FIGS. 8(a)-8(d). Pursuant to fundamental optical theory, to view an object through the triangular prism 100, the following scenarios can occur. When a light path is perpendicular to the triangular prism 100 (which means that the angle 70 equals either 0 or 180 degrees) no refraction occurs. When the angle 70 is greater than 0 but less than 90 degree, the generated refraction causes the horizontal displacement shifted to the left and the vertical displacement shifted backward as illustrated in FIG. 12. When the angle 70 is greater than 90 degree but less than 180 degree, the generated refraction causes the horizontal displacement shifted to the right and the vertical displacement shifted backward. Accordingly, spatial displacement modifications can be achieved by varying the angle of the triangular prism 100 relative to a horizontal axis.

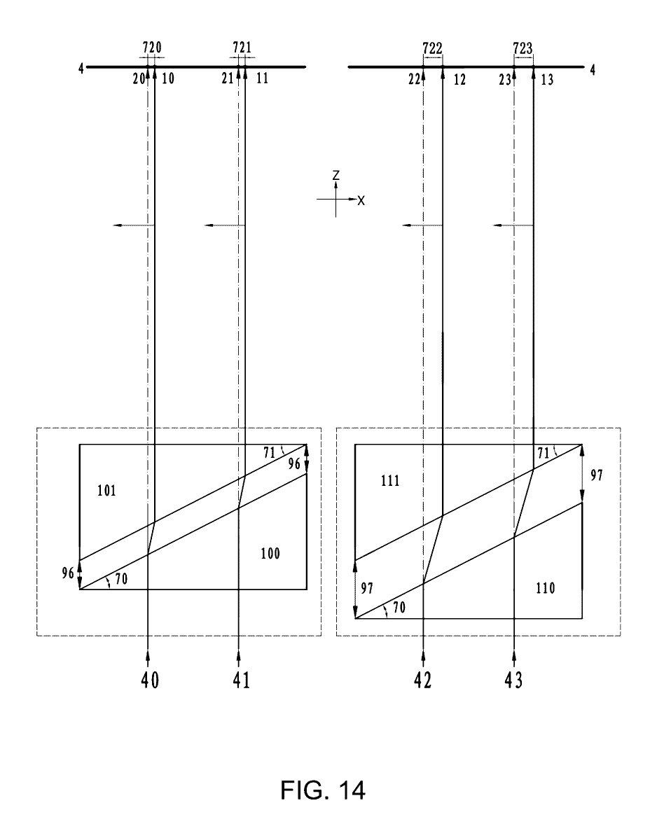

Referring to FIG. 14, a lens assembly (e.g., either 5L or 5R) of the glass 5 may include the following optical elements: a triangular prism 100 with a vertex angle 70 and an opposing triangular prism 101 with a vertex angle 71 separated by the separation space 96 as shown on left portion of FIG. 14 or a triangular prism 110 with a vertex angle 70 and an opposing triangular prism 111 with a vertex angle 71 separated by the separation space 97 as shown on right portion of FIG. 14. The only difference between the left portion and the right portion of FIG. 14 is that the size of the separation space 97 is greater than the size of the separation space 96. When viewed the two objective points 10, 11 through the optical elements 100, 101, due to refraction, the viewing pathways 40, 41 experienced spatial deflection shown by corresponding image points 20, 21. The spatial displacement includes the horizontal displacement 720, 721 shifted to the left and zero vertical displacement. When viewed two objective points 12, 13 through the optical elements 110 and 111, due to refraction, the viewing pathways 42, 43 experienced spatial deflection shown by respective image points 22, 23. The spatial displacement includes the horizontal displacement 722, 723 shifted to the left and zero vertical displacement. Comparing the left portion and the right portion of FIG. 14, it is clear that when all other structures are the same, a larger separation space (97 vs. 96) leads to greater horizontal displacement (722 and 723 versus 720, 721). Accordingly, modification of the amount of horizontal displacement or horizontal parallax to be provided by each lens assembly (5L, or 5R) can be regulate by the size of the separation space (96, 97). The size of the separation space(s) can be made to be an optional adjustment for each of the lens assembly (e.g., see the adjustment mechanism 38 illustrated in FIG. 6).

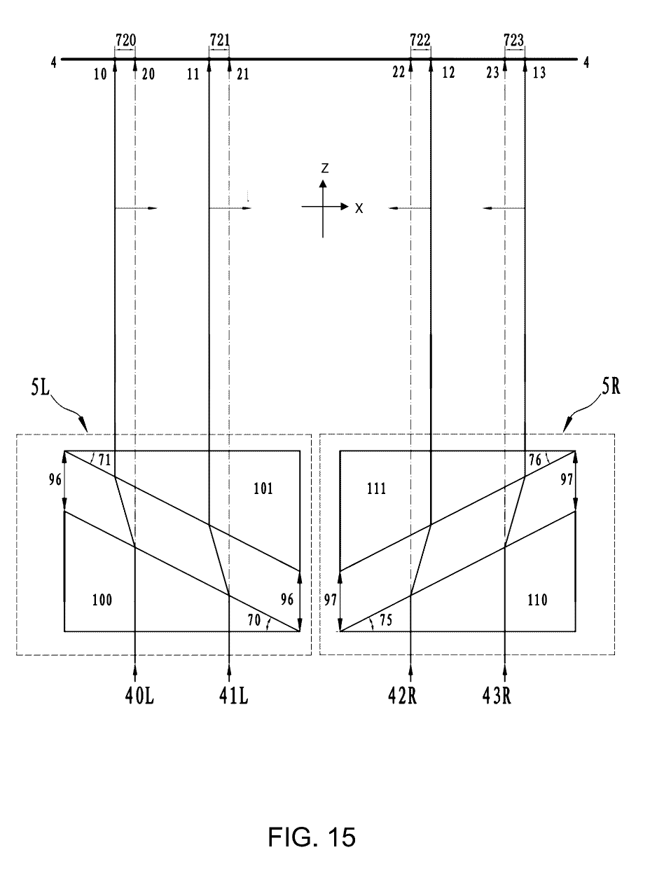

Referring to FIG. 15 and in this embodiment, the left lens assembly 5L includes optical elements that are two opposing triangular prisms 100, 101 forming a separation space 96. The prisms 100, 101 have two vertex angles (70, 71). The right lens assembly 5R is positioned as mirroring of the left lens assembly 5L relative to the central advancing axis. The right lens assembly 5R includes triangular prisms 110, 111 with two vertex angles 75, 76. The prisms 110 and 111 form a separation space 97. Due to the fact that the left lens assembly 5L and the right lens assembly 5R are mirroring each other, the separation space 96, 97 together forms a “V” shape. When viewed the objective points 10 and 11 through the left lens assembly 5L, due to refraction, the viewing pathways 40L, 41L experienced spatial deflection shown by respective image points 20 and 21. There is no vertical displacement for this embodiment of the left lens assembly 5L. The horizontal displacement (720, 721) of the left eye image of the 2D image shown on the screen 4 is to the right. When viewed the objective points 12 and 13 through the right lens assembly 5R, due to refraction, the viewing pathways 42R, 43R experienced spatial deflection shown by respective image points 22 and 23. There is no vertical displacement for this embodiment of the left lens assembly 5L. The horizontal displacement (722, 723) of the right-eye image of the 2D image shown on the screen 4 is to the left. Accordingly, this embodiment provides a zero parallax hyperstereo viewing mode.

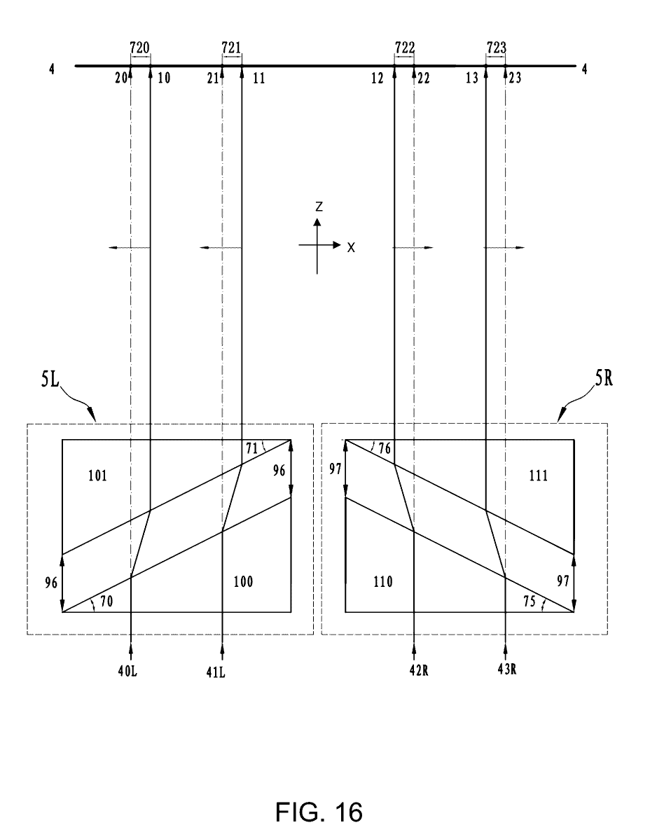

Referring to FIG. 16 and the lens assemblies (5L, 5R) of this embodiment together forms a mirroring of the lens assemblies (5L, 5R) of the embodiment shown in FIG. 15 relative to the central horizontal axis resulting in the separation spaces 96, 97 forming an upside down “V” shape. There is no vertical displacement for this embodiment of the lens assemblies (5L, 5R). When viewed the two objective points 10, 11 through the optical elements 100, 101, due to refraction, the viewing pathways 40L, 41L experienced spatial deflection shown by corresponding image points 20, 21. The horizontal displacement (720, 721) of the left eye image of the 2D image shown on the screen 4 is to the left. When viewed the two objective points 12, 13 through the optical elements 110, 111, due to refraction, the viewing pathways 42R, 43R experienced spatial deflection shown by corresponding image points 22, 23. The horizontal displacement (722, 723) of the right-eye image of the 2D image shown on the screen 4 is to the right. Accordingly, this embodiment of the lens assemblies (5L, 5R) provides a zero parallax hypostereo viewing mode.

A comparison the two embodiments illustrated in FIGS. 15-16 reveals that their difference is basically a swap or exchange between the right lens assembly 5R and the left lens assembly 5L or vice versa. Examination of the resulting left eye images and right eye images reveals that (i) the orientation of the set of opposite triangular prisms (100 & 101; 110 & 111) determines the resulting stereoscopic viewing mode (e.g., hyperstereo versus hypostereo); and (ii) changing the separation space distance/width varies the horizontal parallax. Without the separation space 96, 97, both of the lens assemblies (5L, 5R) will form a rectangular prism.

Referring to FIGS. 15-16, the entire structure (e.g., optical elements 100 and 101 along with separation space 96 of the left lens assembly 5L and the entire structure (e.g., optical elements 110 and 111 along with separation space 97) of the right lens assembly 5R can be angled similar to the angles 60, 61 as illustrated in FIGS. 10-11 in order to modify the spatial parallax. Depending upon the direction of the angles (60, 61), this modified alternative embodiment of the lens assemblies (5L, 5R) can provide either the positive parallax hyperstereo viewing mode as illustrated in FIG. 8(a) or the positive parallax hypostereo viewing mode as illustrated in FIG. 8(c).

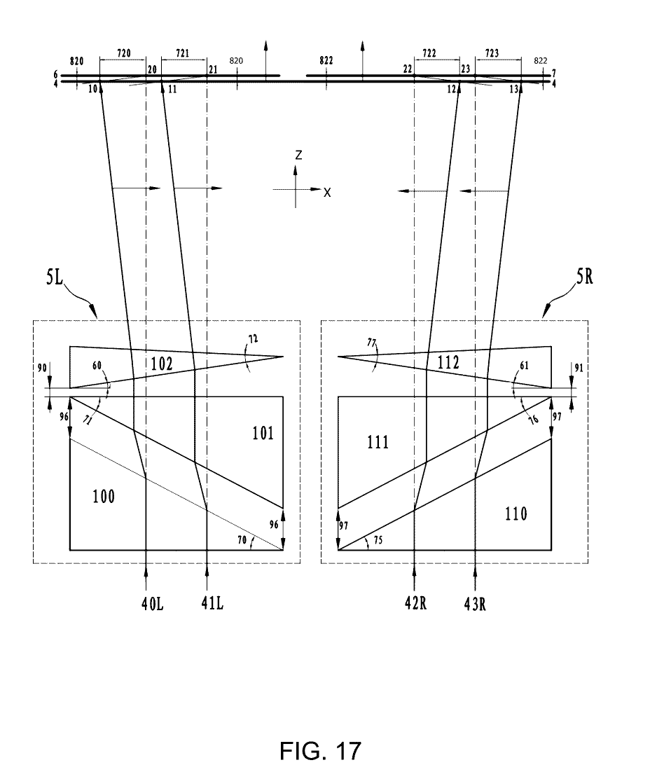

Referring to FIG. 17 and in this embodiment, the left lens assembly 5L of the glasses 5 is comprised of a composite of three triangular prisms 100, 101, 102 as its optical elements. This composite structure is basically formed by placing a triangular prism 102 with a vertex angle 72 and a variable angle 60 on top of the set of opposing triangular prisms 100, 101 with vertex angles 70, 71 and separation space 96 as illustrated in FIG. 15 wherein a separation space 90 separates the triangular prism 102 from the triangular prism 101. The right lens assembly 5R is mirroring of the left lens assembly with triangular prism 110, 111, 112 with vertex angles 75, 76, 77 and variable angle 61 and the separation spaces 97 and 91. When viewed the two objective points 10, 11 of a 2D image shown on the planar screen 4 through the left lens assembly 5L, due to refraction, the viewing pathways 40L, 41L experienced spatial deflection shown by corresponding image points 20, 21 on the left eye image plane 6. The horizontal displacement (721, 722) of the left-eye image is to the right. When viewed the two objective points 12, 13 of a 2D image shown on the planar screen 4 through the right lens assembly 5R, due to refraction, the viewing pathways 42R, 43R experienced spatial deflection shown by corresponding image points 22, 23 on the right eye image plane 7. The horizontal displacement (722, 723) of the right-eye image is to the left. The left eye image plane 6 and the right eye image plane 7 are located in back of (or backward from) the screen 4 resulting in backward vertical displacement 820, 822. Accordingly, this embodiment provides a positive parallax hyperstereo viewing mode as illustrated in FIG. 8(a).

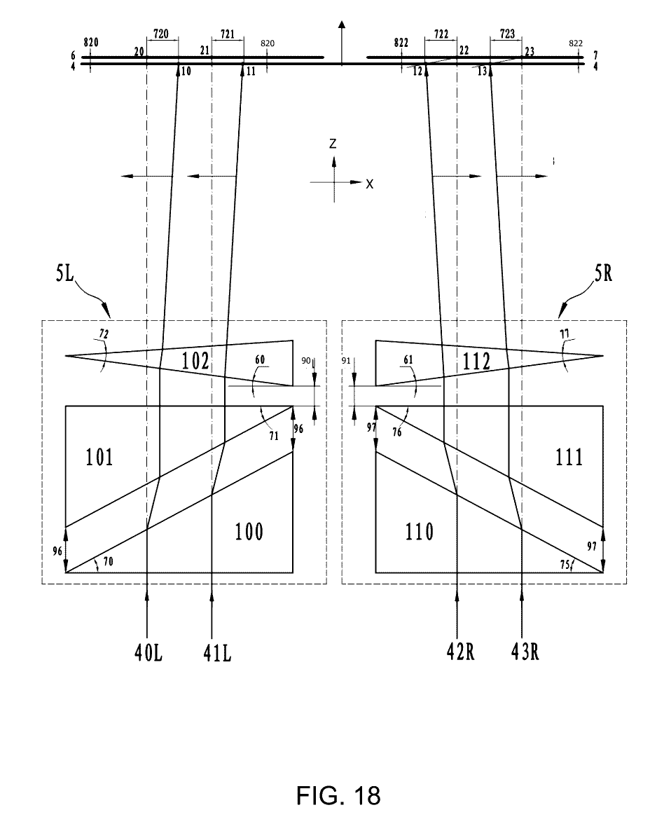

Referring to FIG. 18, this embodiment of the lens assemblies (5L, 5R) of the glasses 5 is basically the same as the embodiment illustrated in FIG. 17 except that the triangular prism 102 with vertex angle 72 and the triangular prism 112 with vertex angle 77 no longer have their vertex angles 72 and 77 facing each other. Instead, the vertex angles 72 and 77 of the triangular prisms 102 and 112 are now facing away from each other as illustrated in FIG. 18. When viewed two objective points 10, 11 of a 2D image shown on the planar screen 4 through the left lens assembly 5L, due to refraction, the viewing path the viewing pathways 40L, 41L experienced spatial deflection shown by corresponding image points 20, 21 on the left eye image plane 6. The horizontal displacement (721, 722) of the left-eye image is to the left. When viewed the two objective points 12, 13 of a 2D image shown on the planar screen 4 through the right lens assembly 5R, due to refraction, the viewing pathways 42R, 43R experienced spatial deflection shown by corresponding image points 22, 23 on the right eye image plane 7. The horizontal displacement (722, 723) of the right-eye image is to the right. The left eye image plane 6 and the right eye image plane 7 are located in back of (or backward from) the screen 4 resulting in backward vertical displacement 820, 822. Accordingly, this embodiment provides a positive parallax hypostereo viewing mode as illustrated in FIG. 8(c).

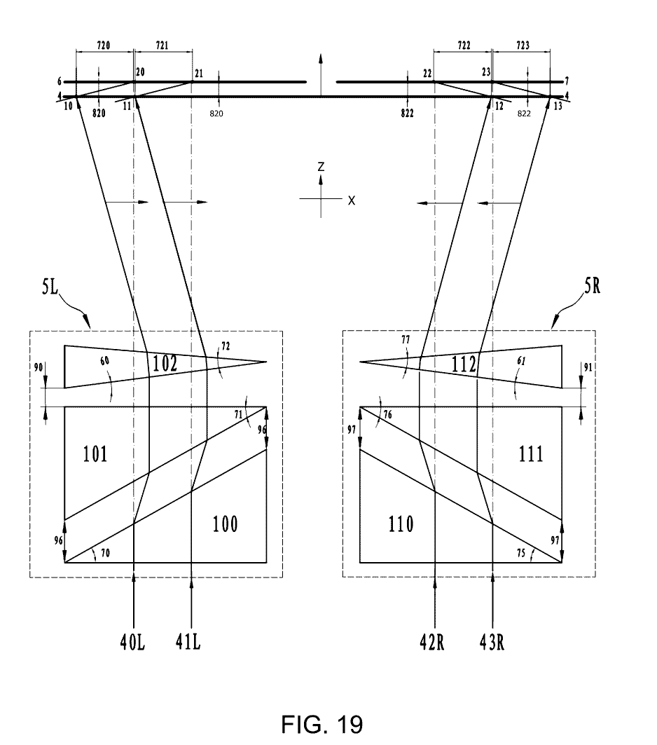

Referring to FIG. 19 and in this embodiment, the left lens assembly 5L of the glasses 5 is comprised of a composite of three triangular prisms 100, 101, 102 as its optical elements. This composite structure is basically formed by placing a triangular prism 102 with a vertex angle 72 and variable angle 60 on top of the set of opposing triangular prisms 100, 101 with vertex angles 70, 71 and separation space 96 as illustrated in FIG. 16 wherein a separation space 90 separates the triangular prism 102 from the triangular prism 101. The right lens assembly 5R is a mirror image of the left lens assembly with triangular prism 110, 111, 112 with vertex angles 75, 76, 77 and variable angle 61 and the separation spaces 97 and 91. When viewed the two objective points 10, 11 of a 2D image shown on the planar screen 4 through the left lens assembly 5L, due to refraction, the viewing pathways 40L, 41L experienced spatial deflection shown by corresponding image points 20, 21 on the left eye image plane 6. The horizontal displacement (721, 722) of the left-eye image is to the right. When viewed the two objective points 12, 13 of a 2D image shown on the planar screen 4 through the right lens assembly 5R, due to refraction, the viewing pathways 42R, 43R experienced spatial deflection shown by corresponding image points 22, 23 on the right eye image plane 7. The horizontal displacement (722, 723) of the right-eye image is to the left. The left eye image plane 6 and the right eye image plane 7 are located in back of (or backward from) the screen 4 resulting in backward vertical displacement 820, 822. Accordingly, this embodiment provides a positive parallax hyperstereo viewing mode as illustrated in FIG. 8(a).

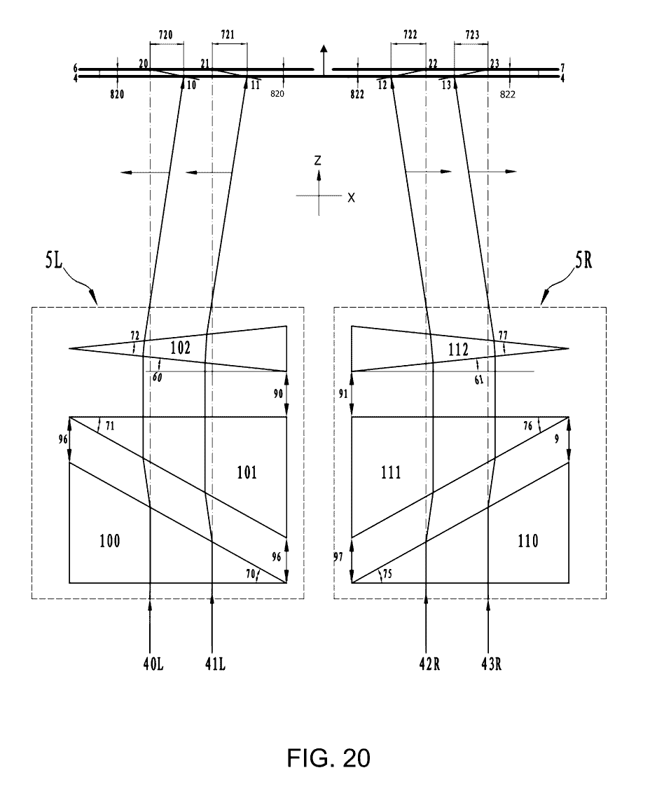

Referring to FIG. 20, this embodiment of the lens assemblies (5L, 5R) of the glasses 5 is basically the same as the embodiment illustrated in FIG. 19 except that the triangular prism 102 with vertex angle 72 and the triangular prism 112 with vertex angle 77 no longer have their vertex angles 72 and 77 facing each other. Instead, the vertex angles 72 and 77 of the triangular prisms 102 and 112 are now facing away from each other as illustrated in FIG. 20. When viewed two objective points 10, 11 of a 2D image shown on the planar screen 4 through the left lens assembly 5L, due to refraction, the viewing pathways 40L, 41L experienced spatial deflection shown by corresponding image points 20, 21 on the left eye image plane 6. The horizontal displacement (721, 722) of the left-eye image is to the left. When viewed the two objective points 12, 13 of a 2D image shown on the planar screen 4 through the right lens assembly 5R, due to refraction, the viewing pathways 42R, 43R experienced spatial deflection shown by corresponding image points 22, 23 on the right eye image plane 7. The horizontal displacement (722, 723) of the right-eye image is to the right. The left eye image plane 6 and the right eye image plane 7 are located in back of (or backward from) the screen 4 resulting in backward vertical displacement 820, 822. Accordingly, this embodiment provides a positive parallax hypostereo viewing mode as illustrated in FIG. 8(c).

The embodiments illustrated in FIGS. 17 and 19 both provide positive parallax hyperstereo viewing mode as illustrated in FIG. 8(a). Assuming the vertex angles 70, 71, 72, 75, 76, 77, variable angles 60, 61, and separation spaces (90, 91, 96, 97) in these two embodiments are the same, it is interesting to note that the viewing pathways go through the optical elements 100, 101, and 102 as illustrated in FIG. 17 all generate the horizontal displacement to the right. However, in the FIG. 19 embodiment, the viewing pathways go through the optical elements 100, 101, 102, only optical elements 100 and 101 generate horizontal displacement to the left while the optical element 102 generate horizontal displacement to the right, partially offsetting the horizontal displacement generated by the optical element 100 and 101. This offsetting effect shall hereinafter be referred to as an “offset”. Accordingly, a comparison of the viewing pathways (e.g., light paths) and spatial parallax reveals that the spatial parallax of the embodiment illustrated in FIG. 17 is greater than the spatial parallax of the embodiment illustrated in FIG. 19. Due to the fact that the FIG. 17 embodiment does not have the offset provided by the FIG. 19 embodiment, the effect of hyperstereo viewing provided by FIG. 17 is greater than the effect of hyperstereo viewing provided by FIG. 19.

The embodiments illustrated in FIGS. 18 and 20 both provide positive parallax hypostereo viewing mode as illustrated in FIG. 8(c). Assuming the vertex angles 70, 71, 72, 75, 76, 77, variable angles 60, 61, and separation spaces (90, 91, 96, 97) in these two embodiments are the same, it is interesting to note that the viewing pathways go through the optical elements 100, 101, and 102 as illustrated in FIG. 18 all generate the horizontal displacement to the left. However, in the FIG. 20 embodiment, the viewing pathways go through the optical elements 100, 101, 102, only optical elements 100 and 101 generate horizontal displacement to the right while the optical element 102 generate horizontal displacement to the left, partially offsetting the horizontal displacement generated by the optical element 100 and 101. Accordingly, a comparison of the viewing pathways (e.g., light paths) and spatial parallax reveals that the spatial parallax of the embodiment illustrated in FIG. 18 is greater than the spatial parallax of the embodiment illustrated in FIG. 20. Due to the fact that the FIG. 18 embodiment does not have the offset provided by the FIG. 20 embodiment, the effect of hypostereo viewing provided by FIG. 18 is greater than the effect of hypostereo viewing provided by FIG. 20.

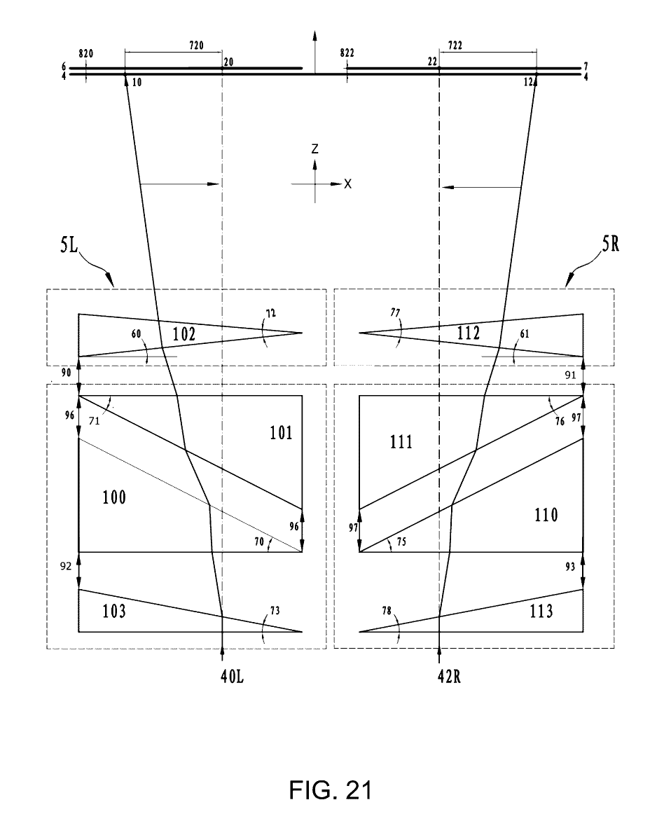

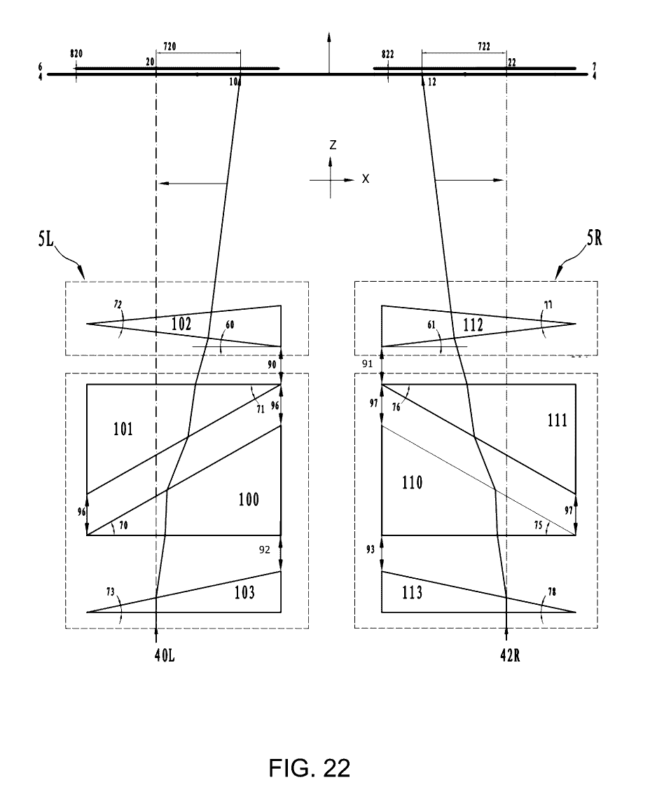

Referring to FIG. 21 and in this embodiment, the left lens assembly 5L of the glasses 5 is comprised of a composite of four triangular prisms 100, 101, 102, 103 with vertex angles 70, 71, 72, 73 and variable angle 60 and the separation spaces 90, 92, and 96 as its optical elements. This composite structure is basically formed by placing the triangular prism 103 with a vertex angle 73 below the left lens assembly illustrated in FIG. 17 with a separation space 92 between the triangular prism 103 and the triangular prism 100. The right lens assembly 5R is mirroring of the left lens assembly with triangular prism 110, 111, 112, 113 with vertex angles 75, 76, 77, 78 and variable angle 61 and the separation spaces 91, 93, and 97. When viewed the objective point 10 of a 2D image shown on the planar screen 4 through the left lens assembly 5L, due to refraction, the viewing pathways 40L experienced spatial deflection shown by corresponding image point 20 on the left eye image plane 6. The horizontal displacement (720) of the left-eye image is to the right. When viewed the objective point 12 of a 2D image shown on the planar screen 4 through the right lens assembly 5R, due to refraction, the viewing pathways 42R experienced spatial deflection shown by corresponding image point 22 on the right eye image plane 7. The horizontal displacement 722 of the right-eye image is to the left. The left eye image plane 6 and the right eye image plane 7 are located in back of (or backward from) the screen 4 resulting in backward vertical displacement 820, 822. Accordingly, this embodiment provides a positive parallax hyperstereo viewing mode as illustrated in FIG. 8(a).

Referring to FIG. 22 and in this embodiment, the left lens assembly 5L of the glasses 5 is comprised of a composite of four triangular prisms 100, 101, 102, 103 with vertex angles 70, 71, 72, 73 and variable angle 60 and the separation spaces 92, 96, and 97 as its optical elements. This composite structure is basically formed by placing the triangular prism 103 with a vertex angle 73 below the left lens assembly illustrated in FIG. 18 with a separation space 92 between the triangular prism 103 and the triangular prism 100. The right lens assembly 5R is mirroring of the left lens assembly with triangular prism 110, 111, 112, 113 with vertex angles 75, 76, 77, 78 and variable angle 61 and the separation spaces 91, 93, and 97. When viewed the objective point 10 of a 2D image shown on the planar screen 4 through the left lens assembly 5L, due to refraction, the viewing pathways 40L experienced spatial deflection shown by corresponding image point 20 on the left eye image plane 6. The horizontal displacement (720) of the left-eye image is to the left. When viewed the objective point 12 of a 2D image shown on the planar screen 4 through the right lens assembly 5R, due to refraction, the viewing pathways 42R experienced spatial deflection shown by corresponding image point 22 on the right eye image plane 7. The horizontal displacement 722 of the right-eye image is to the right. The left eye image plane 6 and the right eye image plane 7 are located in back of (or backward from) the screen 4 resulting in backward vertical displacement 820, 822. Accordingly, this embodiment provides a positive parallax hypostereo viewing mode as illustrated in FIG. 8(c).

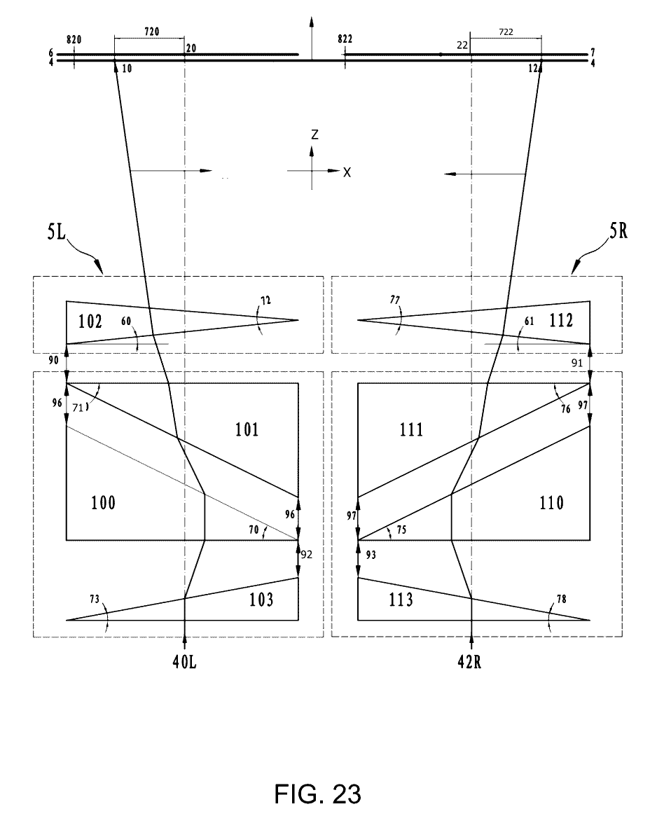

Referring to FIG. 23, this embodiment of the lens assemblies (5L, 5R) of the glasses 5 is basically the same as the embodiment illustrated in FIG. 21 except that the triangular prism 103 with vertex angle 73 and the triangular prism 113 with vertex angle 78 no longer have their vertex angles 73 and 78 facing each other. Instead, the vertex angles 73 and 78 of the triangular prisms 103 and 113 are now facing away from each other as illustrated in FIG. 23. When viewed the objective point 10 of a 2D image shown on the planar screen 4 through the left lens assembly 5L, due to refraction, the viewing pathways 40L experienced spatial deflection shown by corresponding image point 20 on the left eye image plane 6. The horizontal displacement (720) of the left-eye image is to the right. When viewed the objective point 12 of a 2D image shown on the planar screen 4 through the right lens assembly 5R, due to refraction, the viewing pathways 42R experienced spatial deflection shown by corresponding image point 22 on the right eye image plane 7. The horizontal displacement 722 of the right-eye image is to the left. The left eye image plane 6 and the right eye image plane 7 are located in back of (or backward from) the screen 4 resulting in backward vertical displacement 820, 822. Accordingly, this embodiment provides a positive parallax hyperstereo viewing mode as illustrated in FIG. 8(a).

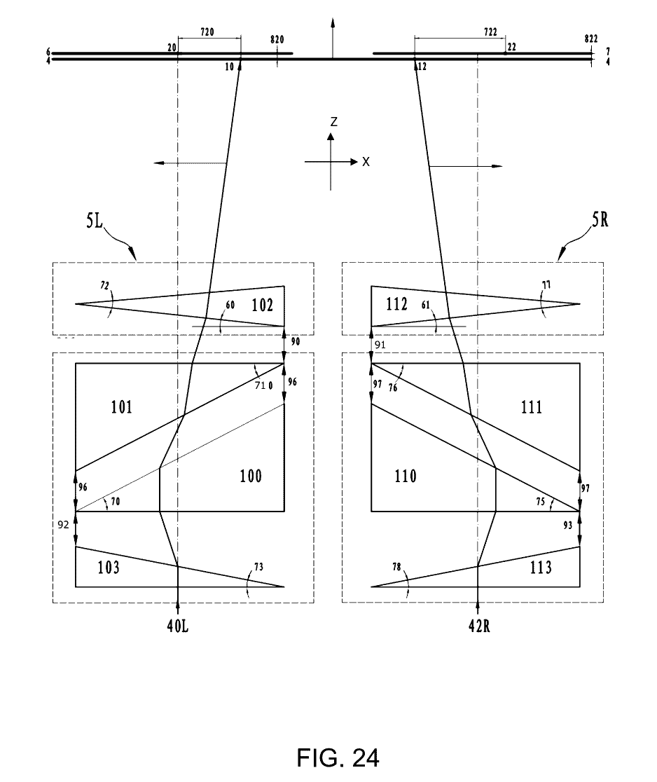

Referring to FIG. 24, this embodiment of the lens assemblies (5L, 5R) of the glasses 5 is basically the same as the embodiment illustrated in FIG. 21 except that the triangular prism 103 with vertex angle 73 and the triangular prism 113 with vertex angle 78 no longer have their vertex angles 73 and 78 facing away from each other. Instead, the vertex angles 73 and 78 of the triangular prisms 103 and 113 are now facing each other as illustrated in FIG. 24. When viewed the objective point 10 of a 2D image shown on the planar screen 4 through the left lens assembly 5L, due to refraction, the viewing pathways 40L experienced spatial deflection shown by corresponding image point 20 on the left eye image plane 6. The horizontal displacement (720) of the left-eye image is to the left. When viewed the objective point 12 of a 2D image shown on the planar screen 4 through the right lens assembly 5R, due to refraction, the viewing pathways 42R experienced spatial deflection shown by corresponding image point 22 on the right eye image plane 7. The horizontal displacement 722 of the right-eye image is to the right. The left eye image plane 6 and the right eye image plane 7 are located in back of (or backward from) the screen 4 resulting in backward vertical displacement 820, 822. Accordingly, this embodiment provides a positive parallax hypostereo viewing mode as illustrated in FIG. 8(c).

The embodiments illustrated in FIG. 21 and FIG. 23 both represent positive parallax hyperstereo viewing mode as illustrated in FIG. 8(a). Assuming the vertex angles (70, 71, 72, 73, 75, 76, 77, 78), the variable angles (60, 61), and the separation spaces (90, 91, 92, 93, 96, 97) as shown in FIGS. 21 and 23 are the same, it is interesting to note that the viewing pathway 40L go through the optical elements 100, 101, 102 and 103 as illustrated in FIG. 21 all generate the horizontal displacement to the right, and the viewing pathway 40R go through the optical elements 110, 111, 112 and 113 as illustrated in FIG. 21 all generate the horizontal displacement to the left. However, in the FIG. 23 embodiment, the viewing pathway 40L go through the optical elements 100, 101, 102 and 103, only optical elements 100, 101 and 102 generate horizontal displacement to the right while the optical element 103 generate horizontal displacement to the left, partially offsetting the horizontal displacement generated by the optical elements 100, 101, and 102; the viewing pathway 42R go through the optical elements 110, 111, 112 and 113, only optical elements 110, 111 and 112 generate horizontal displacement to the left while the optical element 103 generate horizontal displacement to the right, partially offsetting the horizontal displacement generated by the optical elements 110, 111, and 112. Accordingly, a comparison of the viewing pathways (e.g., light paths) and spatial parallax reveals that the spatial parallax of the embodiment illustrated in FIG. 21 is greater than the spatial parallax of the embodiment illustrated in FIG. 23. Due to the fact that the FIG. 21 embodiment does not have the offset provided by the FIG. 23 embodiment, the effect of hyperstereo viewing provided by FIG. 21 is greater than the effect of hyperstereo viewing provided by FIG. 23.

The embodiments illustrated in FIG. 22 and FIG. 24 both represent positive parallax hypostereo viewing mode as illustrated in FIG. 8(c). Assuming the vertex angles (70, 71, 72, 73, 75, 76, 77, 78), the variable angles (60, 61), and the separation spaces (90, 91, 92, 93, 96, 97) as shown in FIGS. 22 and 24 are the same, it is interesting to note that the viewing pathway 40L go through the optical elements 100, 101, 102 and 103 as illustrated in FIG. 22 all generate the horizontal displacement to the left, the viewing pathway 42R go through the optical elements 110, 111, 112 and 113 as illustrated in FIG. 22 all generate the horizontal displacement to the right. However, in the FIG. 24 embodiment, the viewing pathway 40L go through the optical elements 100, 101, 102 and 103, only optical elements 100, 101 and 102 generate horizontal displacement to the left while the optical element 103 generate horizontal displacement to the right, partially offsetting the horizontal displacement generated by the optical elements 100, 101, and 102; the viewing pathway 42R go through the optical elements 110, 111, 112 and 113, only optical elements 110, 111 and 112 generate horizontal displacement to the right while the optical element 113 generate horizontal displacement to the left, partially offsetting the horizontal displacement generated by the optical elements 110, 111, and 112. Accordingly, a comparison of the viewing pathways (e.g., light paths) and spatial parallax reveals that the spatial parallax of the embodiment illustrated in FIG. 22 is greater than the spatial parallax of the embodiment illustrated in FIG. 24. Due to the fact that the FIG. 22 embodiment does not have the offset provided by the FIG. 24 embodiment, the effect of hypostereo viewing provided by FIG. 22 is greater than the effect of hypostereo viewing provided by FIG. 24.

Examination of the embodiments illustrated in FIGS. 10, 17, 19, 21 and 23, all of which provides positive parallax hyperstereo viewing mode as illustrated in FIG. 8(a) reveals that the embodiment illustrated in FIG. 10 requires too much physical space and the center corner of its optical elements 100, 110 can block certain viewing pathway resulting in potential dead viewing area. Accordingly, this embodiment is not as desirable as other embodiments illustrated herein for positive parallax hyperstereo viewing mode. Moreover, it is determined that the embodiment illustrated in FIG. 17 is better than the embodiment illustrated in FIG. 19 in its ability to provide the desired 3D stereoscopic vision of 2D content shown on a planar screen. It is also determined that the embodiment illustrated in FIG. 21 is better than the embodiment illustrated in FIG. 23 in its ability to provide the desired 3D stereoscopic vision of 2D content shown on a planar screen. Since the embodiment illustrated in FIG. 21 includes more optical elements than the embodiment illustrated in FIG. 17, the FIG. 21 embodiment is likely to be thicker and heavier than the FIG. 17 embodiment. Nevertheless, the FIG. 21 embodiment has greater horizontal displacement when compared to the FIG. 17 embodiment so in some applications, it may be the desired choice over FIG. 17 embodiment. It is noted that the FIG. 17 embodiment does give sufficient refraction. Accordingly, the embodiment illustrated in FIG. 17 is likely the most preferred embodiment discussed herein for potential use and commercial application. The embodiment illustrated in FIG. 10 requires too much physical space and the center corner of its optical elements 100, 110 blocked certain viewing pathway which can cause dead viewing area. Accordingly, this embodiment is not as desirable as other embodiments illustrated herein for positive parallax hyperstereo viewing mode.

The embodiments of the lens assemblies (5L, 5R) serve only as examples. The present invention contemplates and includes other combinations of known optical elements for its lens assemblies (5L, 5R) of the glasses 5 as long as such combinations provide the desired 3D stereoscopic vision of a 2D image or content shown on the planar screen 4. It is preferred that the lens assemblies (5L, 5R) provides positive parallax hyperstereo viewing mode as illustrated in FIG. 8(a) or positive parallax hypostereo viewing mode as illustrated in FIG. 8(b) of such 2D content shown on the planar screen.

The present invention also includes, but is not limited to, methods of making and methods of using the glasses 5 for providing 3D stereoscopic vision of viewing 2D content on a planar screen.

The particulars shown herein are by way of example and for purposes of illustrative discussion of the invention only and are presented in the cause of providing what is believed to be the most useful and readily understood description of the principles and conceptual aspects of the invention. In this regard, no attempt is made to show structural details of the invention in more detail than is necessary for the fundamental understanding of the invention, the description taken with the drawings making apparent to those skilled in the art how the several forms of the invention may be embodied in practice. It is understood that the present invention as described and claimed herein can be used for many additional purposes, therefore the invention is within the scope of other fields and uses and not so limited. The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled.

What is claimed is:

1. Optical 3D stereoscopic glasses comprising: a housing, a left lens assembly and a right lens assembly wherein:
(a) when a 2D image shown on a planar screen is viewed by left eye of a viewer through the left lens assembly, the left lens assembly induces the left eye to perceive a left eye offset image of the 2D image which appears to be located at a different spatial location than actual physical location of the 2D image shown on the planar screen in real space;
(b) when a 2D image shown on a planar screen is viewed by right eye of a viewer through the right lens assembly, the right lens assembly induces the right eye to perceive a right eye offset image of the 2D image which appears to be located at a different spatial location than actual physical location of the 2D image shown on a planar screen in real space; and
(c) a spatial difference exists between perceived location of the left eye offset image by the left eye and perceived location of the right eye offset image by the right eye;
(d) the left eye offset image and the right eye offset image created by the glasses (i) fall within at least one of the following viewing modes: positive parallax hyperstereo viewing mode, positive parallax hypostereo viewing mode, negative parallax hyperstereo viewing mode, and negative parallax hypostereo viewing mode; and (ii) causes the viewer to perceive the 2D image shown on the planar screen as a 3D stereoscopic image.

2. The glasses of claim 1 wherein the left eye offset image and the right eye offset image created by the glasses fall within the positive parallax hyperstereo viewing mode.

3. The glasses of claim 1 wherein the left eye offset image and the right eye offset image created by the glasses fall within the positive parallax hypostereo viewing mode.

4. The glasses of claim 1 wherein each of the left lens assembly and the right lens assembly are comprised of at least one optical element.

5. The glasses of claim 4 wherein the at least one optical element is an optical element selected from a group consisting of optical prisms, lenses, curved mirrors, planar mirrors, and a combination thereof.

6. The glasses of claim 4 wherein the at least one optical element is one of more triangular prisms separated from each other by separation space.

7. The glasses of claim 6 wherein the glasses further include a first adjustment mechanism to adjust area of the separation space.

8. The glasses of claim 4 wherein the at least one optical element is angled at a predetermined degree and the glasses further includes a second adjustment mechanism to adjust the predetermined degree.

9. The glasses of claim 4 wherein the at least one optical element is constructed of material selected from a group consisting of glass, plastic, colloidal, and a combination thereof.

10. The glasses of claim 4 wherein the at least one optical element has no diopter.

11. Optical 3D stereoscopic glasses comprising: a housing, a left lens assembly and a right lens assembly wherein each of the left lens assembly and the right lens assembly includes at least one optical element; refraction of the at least one optical element allows the glasses to reduces planar view effect and to cause a viewer wearing the glasses to perceive a 2D image shown on a planar screen as a 3D stereoscopic image.

12. The glasses of claim 11 wherein the glasses provide the viewer with a positive parallax hyperstereo viewing mode.

13. The glasses of claim 11 wherein the glasses provide the viewer with a positive parallax hypostereo viewing mode.

14. The glasses of claim 11 provide sufficient level of convergence to cause the viewer to perceive the 2D image shown on the planar screen as a 3D stereoscopic image without eyestrain.

15. Optical 3D stereoscopic glasses comprising: a housing, a left lens assembly and a right lens assembly wherein:
(a) each of the left lens assembly and the right lens assembly are comprised of three or more triangular prisms separated from each other by a separation space;
(b) each of the three or more triangular prisms;
(c) the triangular prisms are configured to provide either a positive parallax hyperstereo viewing mode or a positive parallax hypostereo viewing mode to a viewer wearing the glasses and thereby allowing the viewer to perceive a 2D image shown on a planar screen as a 3D stereoscopic image.

16. The glasses of claim 15 wherein the viewing mode is the positive parallax hyperstereo viewing mode.

17. The glasses of claim 15 wherein the viewing mode is the positive parallax hypostereo viewing mode.

18. The glasses of claim 15 wherein the glasses further include a first adjustment mechanism to adjust area of the separation space.

19. The glasses of claim 15 wherein each of the three or more triangular prisms is angled at a predetermine degree and the glasses further includes a second adjustment mechanism to adjust the predetermined degree of at least the outer one of the three or more triangular prisms.

20. The glasses of claim 15 wherein each of the three or more triangular prisms has no diopter.
